(19) United States
(12) Patent Application Publication
(10) Pub. No.: US 2025/0218423 A1
(43) Pub. Date: Jul. 3, 2025

(54) DYNAMIC ADAPTATION OF SPEECH SYNTHESIS BY AN AUTOMATED ASSISTANT DURING AUTOMATED TELEPHONE CALL(S)

(71) Applicant: GOOGLE LLC, Mountain View, CA (US)

(72) Inventor: Sasha Goldshtein, Tel Aviv (IL)

(21) Appl. No.: 18/402,293

(22) Filed: Jan. 2, 2024

Related U.S. Application Data
(60) Provisional application No. 63/615,666, filed on Dec. 28, 2023.

(51) Int. Cl. G10L 13/033; G10L 13/10; H04M 3/527

(52) U.S. Cl. CPC G10L 13/033; G10L 13/10; H04M 3/527

(57) ABSTRACT

Implementations are directed to dynamic adaptation of speech synthesis by an automated assistant during automated telephone call(s). In some implementations, processor(s) can select an initial voice to be utilized by the automated assistant in generating synthesized speech audio data and during an automated telephone call. However, during the automated telephone call, the processor(s) can determine to select an alternative voice to be utilized by the automated assistant in generating synthesized speech audio data and in continuing the automated telephone call. In additional or alternative implementations, and during the automated telephone call, the processor(s) can determine whether to generate any synthesized speech audio data that includes a unique personal identifier on a character-by-character basis or the unique personal identifier on a non-character-by-character basis. In additional or alternative implementations, and during the automated telephone call, the processor(s) can determine whether to inject pause(s) into any synthesized speech audio data that is generated.

### BACKGROUND

Humans may engage in human-to-computer dialogs with interactive software applications referred to as “chatbots,” “automated assistants”, “intelligent personal assistants,” etc. (referred to herein as “automated assistants”). As one example, these automated assistants may correspond to a machine learning model or a combination of different machine learning models, and may be utilized to perform various tasks on behalf of users. For instance, some of these automated assistants can initiate telephone calls and conduct conversations with various human users or other automated assistants during the telephone calls to perform task(s) on behalf of the users (referred to herein as “automated telephone calls”). In performing these automated telephone calls, these automated assistants can cause corresponding instances of synthesized speech to be rendered at a corresponding client device of the various human users, and receive instances of corresponding responses from the various human users. Based on the instances of the synthesized speech and/or the instances of the corresponding responses, these automated assistants can determine a result of performance of the task(s), and cause an indication of the result of the performance of the task(s) to be provided for presentation to the users.

However, in generating these corresponding instances of synthesized speech, these automated assistants typically utilize a single voice. For instance, these automated assistants typically utilize the same text-to-speech (TTS) model and/or the same set of prosodic properties (e.g., intonation, tone, stress, rhythm, etc.) in generating the corresponding instances of synthesized speech throughout a duration of the automated telephone calls. Further, the single voice utilized by these automated assistants is typically robotic and can be off-putting to the various human users that interact with these automated assistants during the automated telephone call. Accordingly, the likelihood of successful completion of the task(s) may be reduced, thereby resulting in wasted computational and/or network resources when performance of the task(s) by these automated assistants fail.

### SUMMARY

Implementations described herein are directed to dynamic adaptation of speech synthesis by an automated assistant during automated telephone call(s). In some implementations, processor(s) of a system can select an initial voice to be utilized by the automated assistant in generating synthesized speech audio data and during an automated telephone call. However, during the automated telephone call, the processor(s) can determine to select an alternative voice to be utilized by the automated assistant in generating synthesized speech audio data and in continuing the automated telephone call. In additional or alternative implementations, and during the automated telephone call, the processor(s) can determine whether to generate any synthesized speech audio data that includes a unique personal identifier on a character-by-character basis or the unique personal identifier on a non-character-by-character basis. In additional or alternative implementations, and during the automated telephone call, the processor(s) can determine whether to inject pause(s) into any synthesized speech audio data that is generated.

In implementations where the processor(s) select the initial voice and then determine to select the alternative voice, the processor(s) can select the initial voice based on one or more criteria, such as a type of entity to be engaged with during the automated telephone call, a particular location associated with the entity to be engaged with during the automated telephone call, whether a phone number associated with the entity to be engaged with during the automated telephone call is a landline or non-landline, and/or other criteria. In some implementations, the various voices described herein can be associated with different sets of prosodic properties that influence, for example, intonation, tone, stress, rhythm, and/or other properties of speech and how the speech is perceived. Accordingly, in these implementations, the different voices described herein can be stored in association with respective sets of prosodic properties that are utilized by a text-to-speech (TTS) model in generating one or more corresponding instances of synthesized speech to be rendered during the automated telephone call. In additional or alternative implementations, the various voices described herein can be associated with different TTS models. Accordingly, in these implementations, the different voices described herein can be stored in association with respective TTS models in generating the one or more corresponding instances of synthesized speech to be rendered during the automated telephone call.

Subsequent to selecting the initial voice, the processor(s) can initiate the automated telephone call with the entity. However, despite selecting the initial voice for utilization during the automated telephone call, the processor(s) can continuously monitor for one or more signals to determine whether to modify the initial voice that was selected. For example, the processor(s) can analyze content of a conversation that includes audio data capturing an interaction between the automated assistant and a representative of the entity, a transcript of the interaction between the automated assistant and a representative of the entity, and/or other content of the conversation. Notably, the representative of the entity can be, for example, a human representative, a voice bot, an interactive voice response (IVR) system, etc. In analyzing the content of the conversation, the processor(s) can dynamically adapt the initial voice utilized in generating the one or more corresponding instances of synthesized speech to the alternative voice that is predicted to maximize success of the automated assistant performing a task during the automated telephone call.

For example, the initial voice that is selected may correspond to an accent or utilize vocabulary that is specific to a geographical region in which the entity is situated. However, upon determining that the representative associated with the entity does not reflect the accent or utilize vocabulary that is specific to the geographical region, the processor(s) can cause the automated assistant to switch to the alternative voice that better reflects that of the representative associated with the entity. Additionally, or alternatively, the initial voice that is selected may result in a first intonation or a first cadence of the synthesized speech being utilized. However, upon determining that the representative associated with the entity has a second intonation or a second cadence, the processor(s) can cause the automated assistant to switch to the alternative voice that better reflects the second intonation or the second cadence.

By selecting the initial voice and then determining to select the alternative voice during the automated telephone call, one or more technical advantages can be achieved. For example, the voice utilized by the automated assistant can be dynamically adapted throughout a duration of the automated telephone call to maximize success of the automated assistant performing the task during the automated telephone call. Although the voice that maximizes success of the automated assistant performing the task during the automated telephone call may be subjective, by causing the automated assistant performing the task to reflect a voice of the representative associated with the entity, the voice will sound objectively better to the representative associated with the entity. As a result, the automated assistant can conclude performance of the task in a more quick and efficient manner since the representative associated with the entity will be more objectively receptive to interacting with the automated assistant will a familiar voice, thereby conserving computational and/or network resources.

In implementations where the processor(s) determine whether to generate the synthesized speech audio data that includes the unique personal identifier on the character-by-character basis or the unique personal identifier on the non-character-by-character basis and/or whether to generate the synthesized speech audio data that includes the pause(s), the processor(s) can make this determination based on one or more criteria, such as a frequency of the unique personal identifier, a length of the unique personal identifier, a complexity of the unique personal identifier, and/or other criteria. Additionally, or alternatively, the processor(s) can make this determination based on whether the representative associated with the entity is a human representative or a non-human representative (e.g., a voice bot associated with the entity, an interactive voice response (IVR) system associated with the entity, etc.).

For example, if the unique personal identifier is frequent in a lexicon of users, then the processor(s) may determine to generate the synthesized speech audio data that includes the unique personal identifier on the non-character-by-character basis and without any pause(s), but if the unique personal identifier is not frequent in a lexicon of users, then the processor(s) may determine to generate the synthesized speech audio data that includes the unique personal identifier on the character-by-character basis and/or with pause(s). As another example, if the unique personal identifier does not include characters beyond a threshold length, then the processor(s) may determine to generate the synthesized speech audio data that includes the unique personal identifier on the non-character-by-character basis and without any pause(s), but if the unique personal identifier does include characters beyond the threshold length, then the processor(s) may determine to generate the synthesized speech audio data that includes the unique personal identifier on the character-by-character basis and/or with pause(s). As yet another example, if a combination of letters and/or numbers of the unique personal is relatively simple, then the processor(s) may determine to generate the synthesized speech audio data that includes the unique personal identifier on the non-character-by-character basis and without any pause(s), but if a combination of letters and/or numbers of the unique personal is relatively complex, then the processor(s) may determine to generate the synthesized speech audio data that includes the unique personal identifier on the character-by-character basis and/or with pause(s). As yet another example, if the representative associated with the entity is a human representative, then the processor(s) may be more likely to render the unique personal identifier on the character-by-character basis and with pause(s). However, if the representative associated with the entity is a non-human representative, then the processor(s) may be more likely to render the unique personal identifier on the non-character-by-character basis and without pause(s) (e.g., since the IVR system and/or the voice bot representative are likely to employ ASR model(s) to interpret any synthesized speech rendered by the automated assistant during the automated telephone call).

By dynamically adapting how the unique personal identifier is synthesized and rendered, one or more technical advantages can be achieved. For example, in implementations where the unique personal identifier is generated on the character-by-character basis for a human representative associated with the entity, instances in which the automated assistant is asked by the human representative to repeat one or more portions of the unique personal identifier or slow down are eliminated and/or mitigated. However, in implementations where the unique personal identifier is generated on the non-character-by-character basis for a non-human representative associated with the entity (but would be generated on the character-by-character basis for a human representative), instances in which the automated assistant interacts with the non-human representative can be concluded in a more quick and efficient manner, thereby conserving computational and/or network resources.

The above description is provided as an overview of only some implementations disclosed herein. Those implementations, and other implementations, are described in additional detail herein.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2 depicts an example process using various components from the example environment from FIG. 1, in accordance with various implementations.

FIG. 3 depicts a flowchart illustrating an example method of switching voices utilized by an automated assistant during an automated telephone call, in accordance with various implementations.

FIG. 4 depicts a flowchart illustrating an example method of dynamically adapting how unique personal identifiers are rendered during an automated telephone call, in accordance with various implementations.

FIG. 5A and FIG. 5B depict various non-limiting examples of switching voices utilized by an automated assistant during an automated telephone call, in accordance with various implementations.

FIG. 6A, FIG. 6B, FIG. 6C, and FIG. 6D depict various non-limiting examples of dynamically adapting how unique personal identifiers are rendered during an automated telephone call, in accordance with various implementations.

FIG. 7 depicts an example architecture of a computing device, in accordance with various implementations.

### DETAILED DESCRIPTION

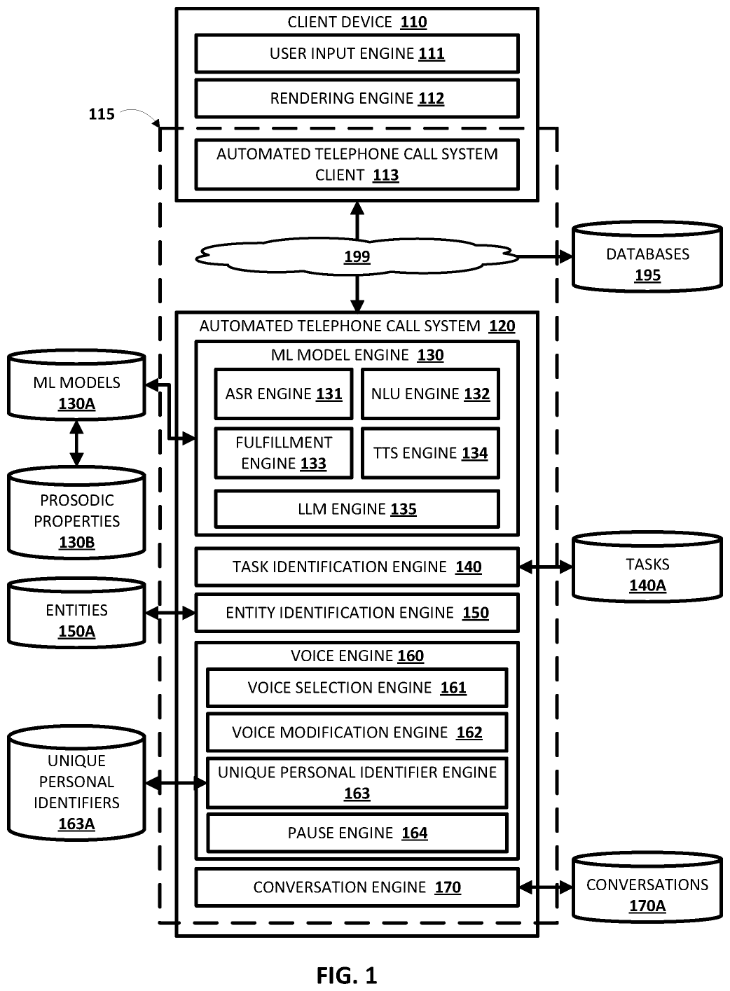

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, a user input engine 111, a rendering engine 112, and an automated telephone call system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device, etc.). Additional and/or alternative client devices may be provided.

The user input engine 111 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input.

The rendering engine 112 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, a transcript of a dialog between a user of the client device 110 and an automated assistant 115 executing at least in part at the client device 110, a transcript of a dialog between the automated assistant 115 executing at least in part at the client device 110 and an additional user that is in addition to the user of the client device 110, notifications, selectable graphical elements, and/or any other content and/or output described herein.

Further, the client device 110 is illustrated in FIG. 1 as communicatively coupled, over one or more networks 199 (e.g., any combination of Wi-Fi®, Bluetooth®, or other local area networks (LANs); ethernet, the Internet, or other wide area networks (WANs); and/or other networks), to an automated telephone call system 120. The automated telephone call system 120 can be, for example, a high-performance server, a cluster of high-performance servers, and/or any other computing device that is remote from the client device 110. The automated telephone call system 120 includes, in various implementations, a machine learning (ML) model engine 130, a task identification engine 140, an entity identification engine 150, a voice engine 160, and a conversation engine 170. The ML model engine 130 can include various sub-engines, such as an automatic speech recognition (ASR) engine 131, a natural language understanding (NLU) engine 132, a fulfillment engine 133, a text-to-speech (TTS) engine 134, and a large language model (LLM) engine 135. These various sub-engines can utilize one or more respective ML models (e.g., stored in ML models database 130A). Further, the voice engine 160 can include various sub-engines, such as voice selection engine 161, a voice modification engine 162, a unique personal identifier engine 163, and a pause engine 164.

The automated telephone call system 120 can leverage various databases. For instance, and as noted above, the ML model engine 130 can the leverage ML models database 130A that stores various ML models and optionally prosodic properties database 130B that stores various sets of prosodic properties; the task identification engine 140 can leverage tasks database 140A that stores various tasks, parameters associated with the various tasks, entities that can be interacted with to perform the various tasks; the entity identification engine 150 can leverage entities database 150A that stores various entities; the unique personal identifier engine 163 can leverage unique personal identifiers database 163A that stores various unique personal identifiers and information associated therewith; and the conversation engine 170 can leverage conversations database 170A that stores various conversations between users, users and automated assistants, between automated assistants, and/or other conversations. Although FIG. 1 is depicted with respect to certain engines and/or sub-engines of the automated telephone call system 120 having access to certain databases, it should be understood that is for the sake of example and is not meant to be limiting.

Moreover, the client device 110 can execute the automated telephone call system client 113. An instance of the automated telephone call system client 113 can be an application that is separate from an operating system of the client device 110 (e.g., installed “on top” of the operating system)—or can alternatively be implemented directly by the operating system of the client device 110. The automated telephone call system client 113 can implement the automated telephone call system 120 locally at the client device 110 and/or remotely from the client device 110 via one or more of the networks 199 (e.g., as shown in FIG. 1). The automated telephone call system client 113 (and optionally by way of its interactions with the automated telephone call system 120) may form what appears to be, from a user's perspective, a logical instance of the automated assistant 115 with which the user may engage in a human-to-computer dialog. An instance of the automated assistant 115 is depicted in FIG. 1, and is encompassed by a dashed line that includes the automated telephone call system client 113 of the client device 110 and the automated telephone call system 120.

Furthermore, the client device 110 and/or the automated telephone call system 120 may include one or more memories for storage of data and software applications, one or more processors for accessing data and executing the software applications, and other components that facilitate communication over one or more of the networks 199. In some implementations, one or more of the software applications can be installed locally at the client device 110, whereas in other implementations one or more of the software applications can be hosted remotely from the client device 110 (e.g., by one or more servers), but accessible by the client device 110 over one or more of the networks 199.

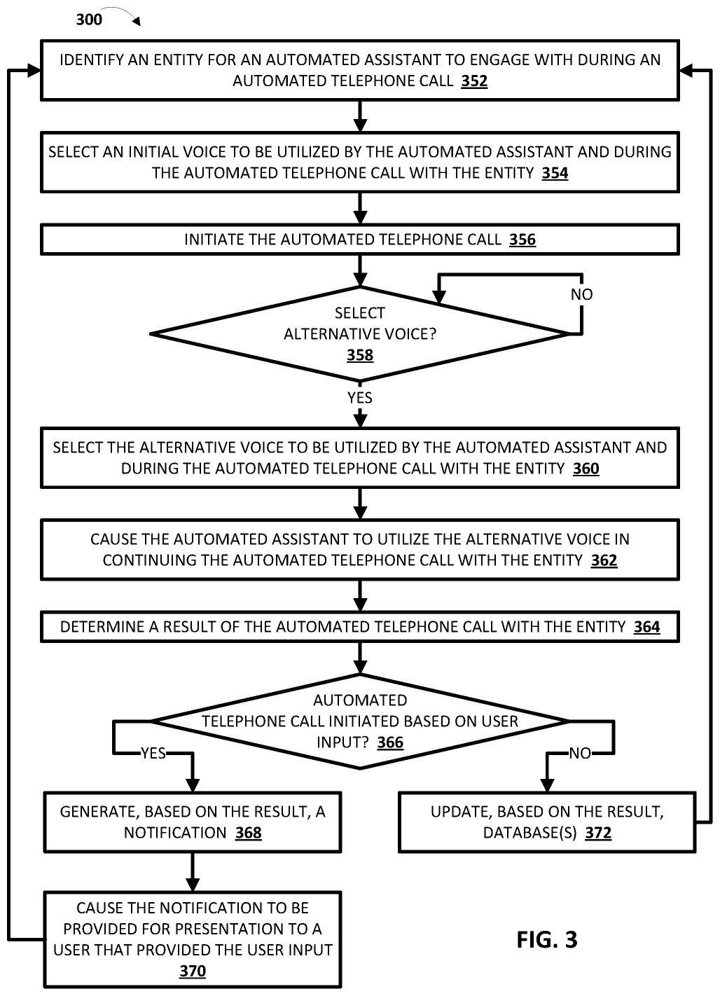

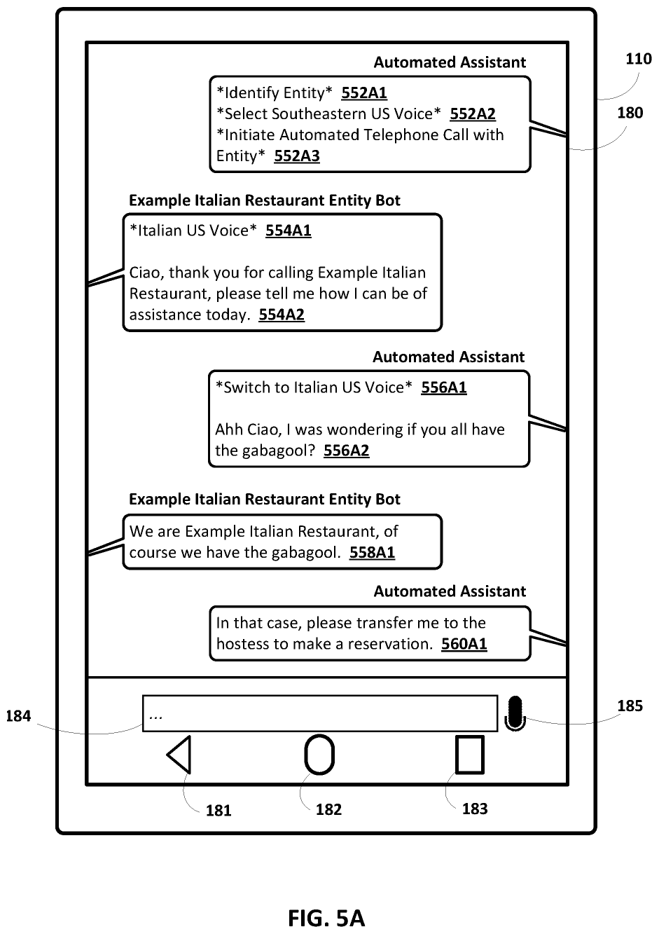

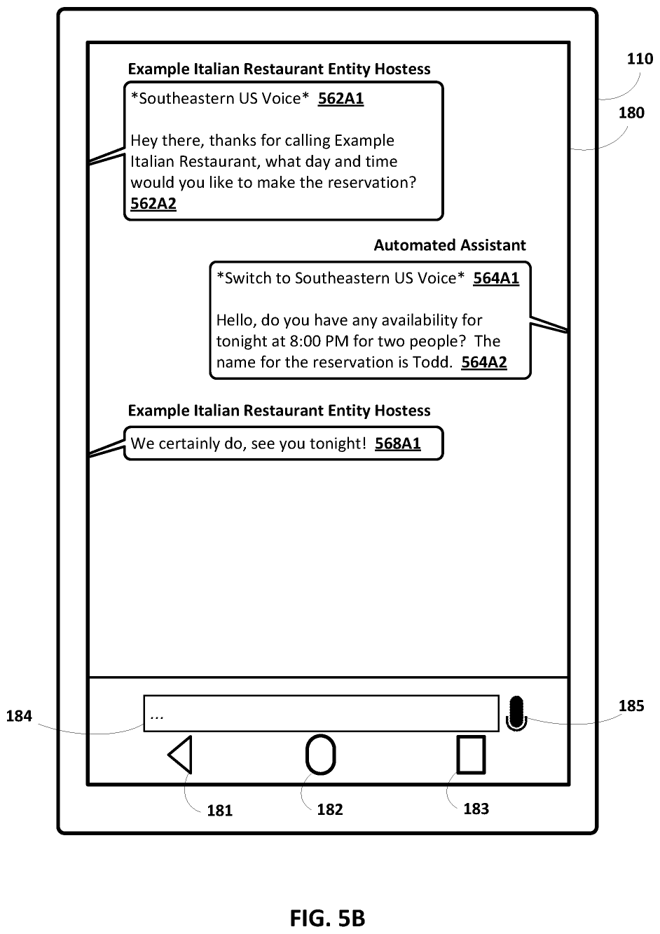

As described herein, the automated telephone call system 120 can be utilized to dynamically adapt speech synthesis by the automated assistant 115 during automated telephone calls in an effort to conserve computational resources and/or network resources. By dynamically adapting the speech synthesis by the automated assistant 115 during the automated telephone calls, the resulting synthesized speech will better resonate with a user that is consuming the synthesized speech. While what resonates with the user that is consuming the synthesized speech will depend on the subjective preferences and goals of the user, the resulting synthesized speech will be made more objectively and conveniently more relevant to the user's subjective preferences. For example, by initially selecting a voice which the automated assistant predicts will best resonate with the user, but being able to dynamically adapt the voice to an alternative voice (e.g., via different TTS model(s) and/or via different sets of prosodic properties) as described herein (e.g., with respect to FIGS. 3, 5A, and 5B), the resulting synthesized speech can better reflect a voice which will resonate with the user, thereby increasing the likelihood that the automated assistant will successfully complete the task and eliminating and/or mitigating instances in which the automated assistant does not successfully complete the task due to the user being frustrated with the voice of the automated assistant or the like.

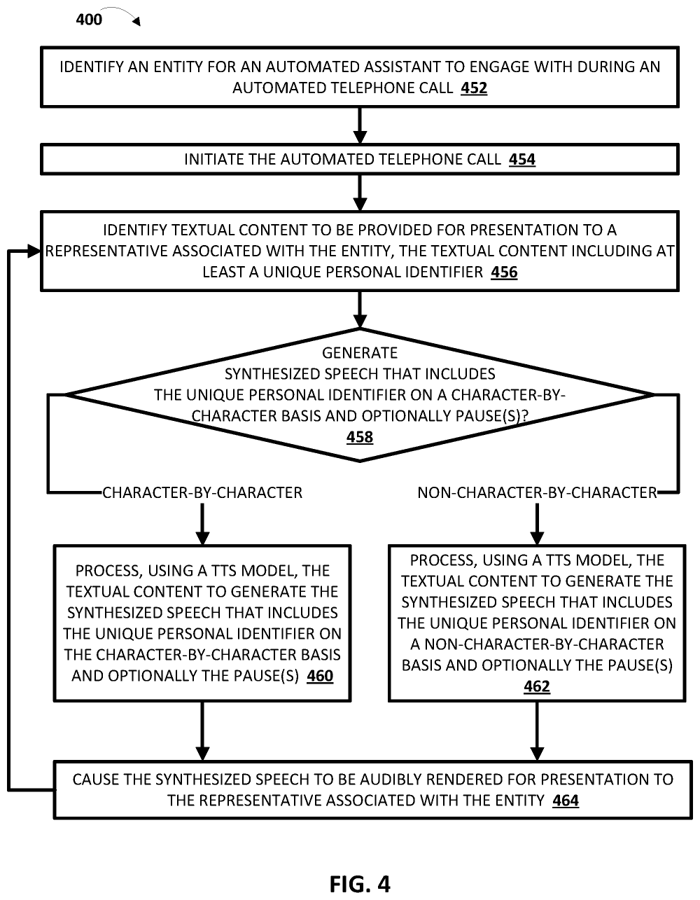

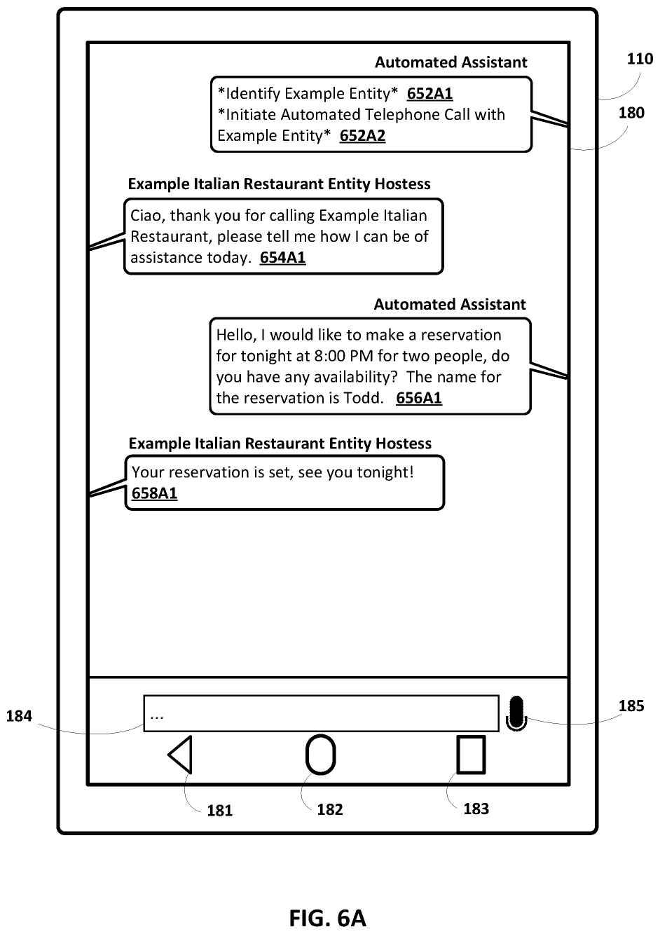

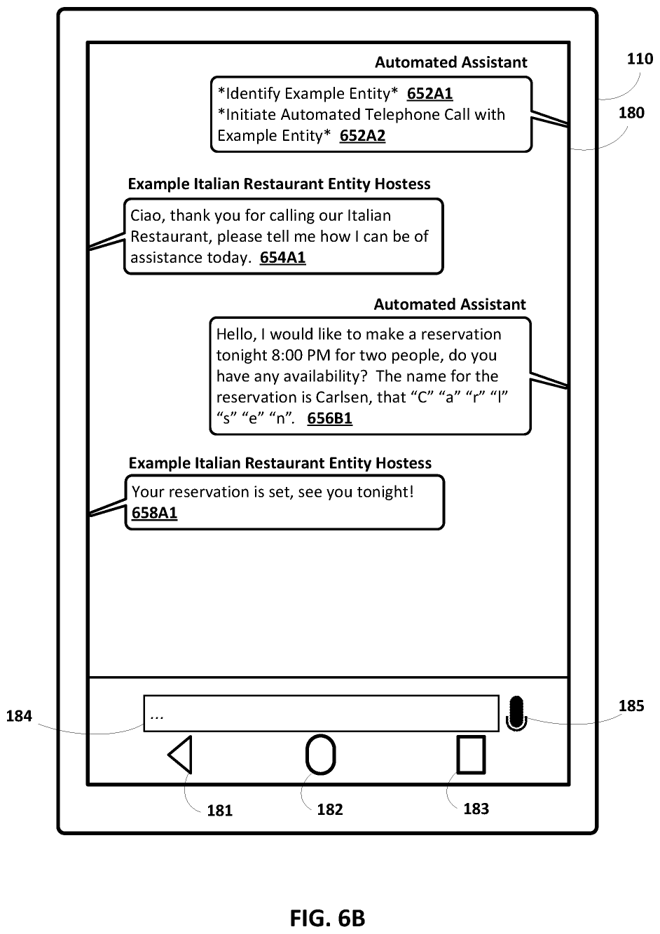

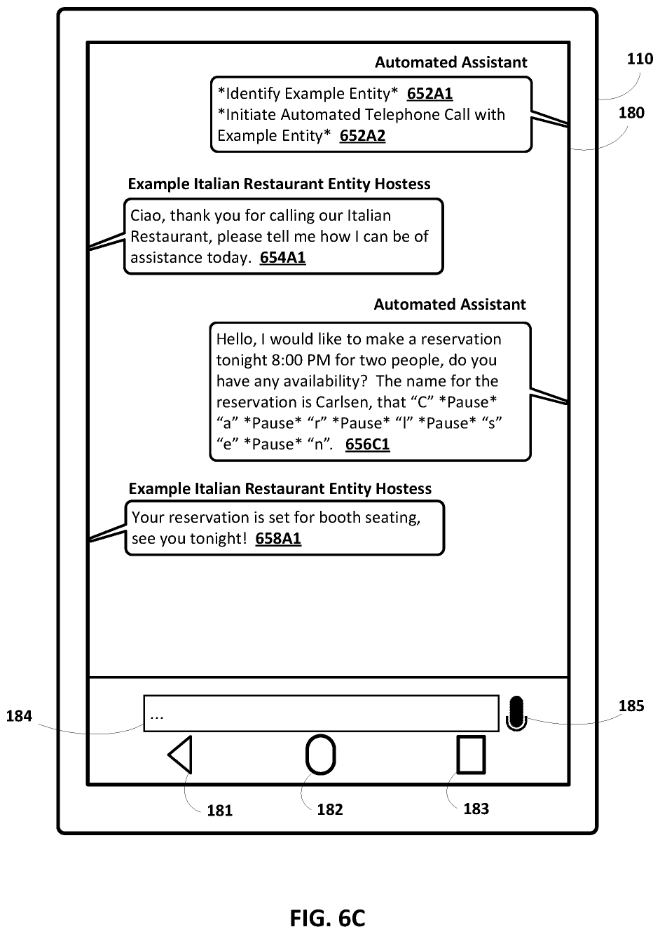

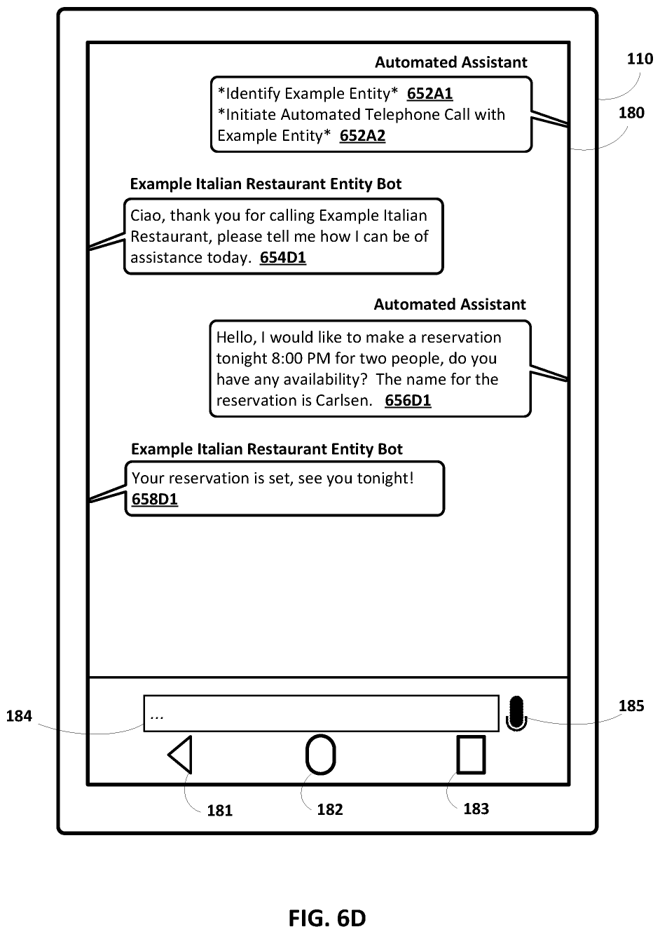

As another example, by determining whether to generate synthesized speech that includes unique personal identifiers on a character-by-character basis (e.g., synthesized speech of “J”, “o”, “h”, “n” or “John with an h” for a unique personal identifier of “John”) or a non-character-by-character basis (e.g., synthesized speech of “John” for the unique personal identifier of “John” where it could be unclear whether an “h” is included based on audible rendering of “John”) based on various factors described herein (e.g., with respect to FIGS. 4, 6A, 6B, 6C, and 6D), the automated assistant can guide the human-to-computer interaction to a conclusion in a more quick and efficient manner, thereby conserving computational and/or network resources by eliminating and/or mitigating instances in which the automated assistant is asked to repeat one or more portions of these unique personal identifiers (e.g., “is that John with or without the ‘h’” if “John” was audibly rendered instead of “J”, “o”, “h”, “n” or “John with an h”). As yet another example, by determining whether to generate synthesized speech that injects pauses in relation to the unique personal identifiers based on various factors described herein (e.g., with respect to FIGS. 4, 6A, 6B, 6C, and 6D), the automated assistant can guide the human-to-computer interaction to a conclusion in a more quick and efficient manner, thereby conserving computational and/or network resources by eliminating and/or mitigating instances in which the automated assistant is asked to repeat one or more portions of these unique personal identifiers or slow down (e.g., while the user performs one or more actions based on the unique personal identifiers).

The automated telephone calls described herein can be conducted by the automated assistant 115. For example, the automated telephone calls can be conducted using Voice over Internet Protocol (VoIP), public switched telephone networks (PSTN), and/or other telephonic communication protocols. Further, the automated telephone calls described herein are automated in that the automated assistant 115 conducts the automated telephone calls using one or more of the components depicted in FIG. 1, on behalf of a user of the client device 110, and the user of the client device 110 is not an active participant in the automated telephone call(s).

In various implementations, the ASR engine 131 can process, using ASR model(s) stored in the ML models database 130A (e.g., a recurrent neural network (RNN) model, a transformer model, and/or any other type of ML model capable of performing ASR), audio data that captures a spoken utterance and that is generated by microphone(s) of the client device 110 (or microphone(s) of an additional client device) to generate ASR output. Further, the NLU engine 132 can process, using NLU model(s) stored in the ML models database 130A (e.g., a long short-term memory (LSTM), gated recurrent unit (GRU), and/or any other type of RNN or other ML model capable of performing NLU) and/or NLU rule(s), the ASR output (or other typed or touch inputs received via the user input engine 111 of the client device 110) to generate NLU output. Moreover, the fulfillment engine 133 can process, using fulfillment model(s) and/or fulfillment rules stored in the ML models database 130A, the NLU data to generate fulfillment output. Additionally, the TTS engine 134 can process, using TTS model(s) stored in the ML models database 130A, textual content (e.g., text formulated by the automated assistant 115) to generate synthesized speech audio data that includes computer-generated synthesized speech. Furthermore, in various implementations, the LLM engine 135 can replace one or more of the aforementioned components. For instance, the LLM engine 135 can replace the NLU engine 132 and/or the fulfillment engine 133. In these implementations, the LLM engine 135 can process, using LLM(s) stored in the ML models database 130A (e.g., PaLM, BARD, BERT, LaMDA, Meena, GPT, and/or any other LLM, such as any other LLM that is encoder-only based, decoder-only based, sequence-to-sequence based and that optionally includes an attention mechanism or other memory), the ASR output (or other typed or touch inputs received via the user input engine 120 of the client device 110) to generate LLM output.

In various implementations, the ASR output can include, for example, a plurality of speech hypotheses (e.g., term hypotheses and/or transcription hypotheses) that are predicted to correspond to spoken utterance(s) based on the processing of audio data that captures the spoken utterance(s). The ASR engine 131 can optionally select a particular speech hypotheses as recognized text for the spoken utterance(s) based on a corresponding value associated with each of the plurality of speech hypotheses (e.g., probability values, log likelihood values, and/or other values). In various implementations, the ASR model(s) stored in the ML model(s) database 130A are end-to-end speech recognition model(s), such that the ASR engine 131 can generate the plurality of speech hypotheses directly using the ASR model(s). For instance, the ASR model(s) can be end-to-end model(s) used to generate each of the plurality of speech hypotheses on a character-by-character basis (or other token-by-token basis). One non-limiting example of such end-to-end model(s) used to generate the recognized text on a character-by-character basis is a recurrent neural network transducer (RNN-T) model. An RNN-T model is a form of sequence-to-sequence model that does not employ attention mechanisms or other memory. In other implementations, the ASR model(s) are not end-to-end speech recognition model(s) such that the ASR engine 131 can instead generate predicted phoneme(s) (and/or other representations). For instance, the predicted phoneme(s) (and/or other representations) may then be utilized by the ASR engine 131 to determine a plurality of speech hypotheses that conform to the predicted phoneme(s). In doing so, the ASR engine 131 can optionally employ a decoding graph, a lexicon, and/or other resource(s). In various implementations, a corresponding transcription that includes the recognized text can be rendered at the client device 110.

In various implementations, the NLU output can include, for example, annotated recognized text that includes one or more annotations of the recognized text for one or more (e.g., all) of the terms of the recognized text. For example, the NLU engine 132 may include a part of speech tagger (not depicted) configured to annotate terms with their grammatical roles. Additionally, or alternatively, the NLU engine 132 may include an entity tagger (not depicted) configured to annotate entity references in one or more segments of the recognized text, such as references to people (including, for instance, literary characters, celebrities, public figures, etc.), organizations, locations (real and imaginary), and so forth. In some implementations, data about entities may be stored in one or more databases, such as in a knowledge graph (not depicted). In some implementations, the knowledge graph may include nodes that represent known entities (and in some cases, entity attributes), as well as edges that connect the nodes and represent relationships between the entities. The entity tagger may annotate references to an entity at a high level of granularity (e.g., to enable identification of all references to an entity class such as people) and/or a lower level of granularity (e.g., to enable identification of all references to a particular entity such as a particular person). The entity tagger may rely on content of the natural language input to resolve a particular entity and/or may optionally communicate with a knowledge graph or other entity database to resolve a particular entity. Additionally, or alternatively, the NLU engine 132 may include a coreference resolver (not depicted) configured to group, or “cluster,” references to the same entity based on one or more contextual cues. For example, the coreference resolver may be utilized to resolve the term “them” to “buy theatre tickets” in the natural language input “buy them”, based on “theatre tickets” being mentioned in a client device notification rendered immediately prior to receiving input “buy them”. In some implementations, one or more components of the NLU engine 132 may rely on annotations from one or more other components of the NLU engine 132. For example, in some implementations the entity tagger may rely on annotations from the coreference resolver in annotating all mentions to a particular entity. Also, for example, in some implementations, the coreference resolver may rely on annotations from the entity tagger in clustering references to the same entity. Also, for example, in some implementations, the coreference resolver may rely on user data of the user of the client device 110 in coreference resolution and/or entity resolution. The user data may include, for example, historical location data, historical temporal data, user preference data, user account data, calendar information, email data, and/or any other user data that is accessible at the client device 110.

In various implementations, the fulfillment output can include, for example, one or more tasks to be performed by the automated assistant 115. For example, the user can provide unstructured free-form natural language input in the form of spoken utterance(s). The spoken utterance(s) can include, for instance, an indication of the one or more tasks to be performed by the automated assistant 115. The one or more tasks may require the automated assistant 115 to provide certain information to the user, engage with one or more external systems on behalf of the user (e.g., an inventory system, a reservation system, etc. via a remote procedure call (RPC)), and/or any other task that may be specified by the user and performed by the automated assistant 115. Accordingly, it should be understood that the fulfillment output may be based on the one or more tasks to be performed by the automated assistant 115 and may be dependent on the corresponding conversations with the user.

In various implementations, the TTS engine 134 can generate synthesized speech audio data that captures computer-generated synthesized speech. The synthesized speech audio data can be rendered at the client device 110 via speaker(s) of the client device 110. The synthesized speech may include any output generated by the automated assistant 115 as described herein, and may include, for example, synthesized speech generated as part of a dialog between the user of the client device 110 and the automated assistant 115, as part of an automated telephone call between the automated assistant 115 and a representative associated with an entity (e.g., a human representative associated with the entity, an automated assistant representative associated with the entity, and interactive voice response (IVR) system associated with the entity, etc.), and so on.

In various implementations, the LLM output can include, for example, a probability distribution over a sequence of tokens, such as words, phrases, or other semantic units, that are predicted to be responsive to the spoken utterance(s) or other user inputs provided by the user of the client device 110 and/or other users (e.g., the representative associated with the entity). Notably, the LLM(s) stored in the ML model(s) database 130A can include billions of weights and/or parameters that are learned through training the LLM on enormous amounts of diverse data. This enables these LLM(s) to generate the LLM output as the probability distribution over the sequence of tokens. In these implementations, the LLM engine 135 can replace the NLU engine 132 and/or the fulfillment engine 133 since these LLM(s) can perform the same or similar functionality in terms of natural language processing.

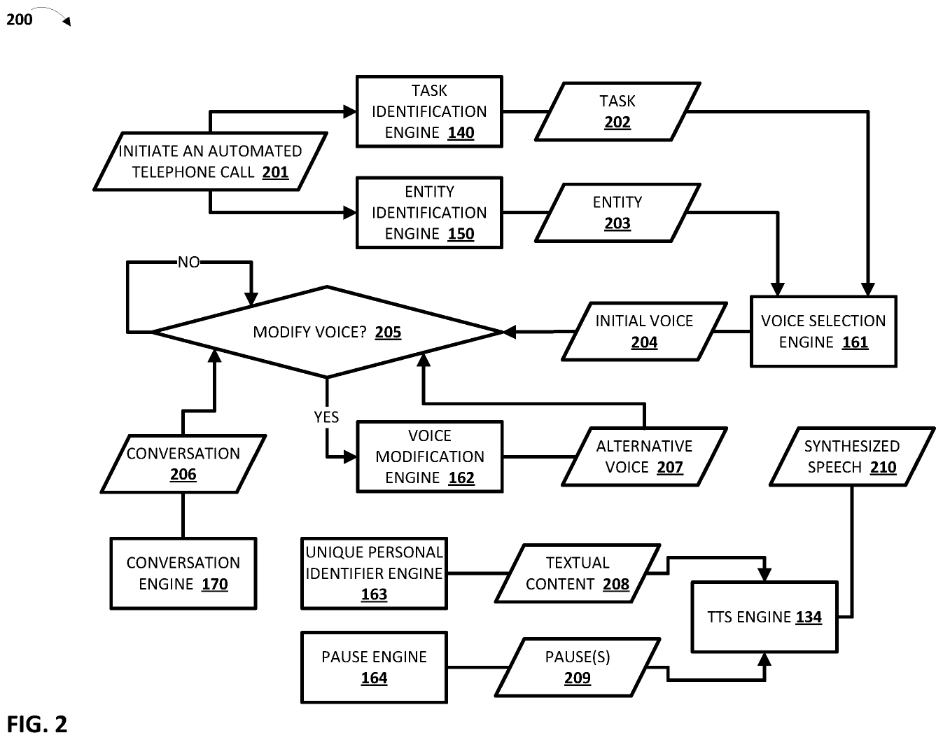

Although FIG. 1 is described with respect to a single client device having a single user, it should be understood that is for the sake of example and is not meant to be limiting. For example, one or more additional client devices of a user can also implement the techniques described herein. For instance, the client device 110, the one or more additional client devices, and/or any other computing devices of the user can form an ecosystem of devices that can employ techniques described herein. These additional client devices and/or computing devices may be in communication with the client device 110 and/or the automated telephone call system 120 (e.g., over the one or more networks 199). As another example, a given client device can be utilized by multiple users in a shared setting (e.g., a group of users, a household, etc.). Additional description of the task identification engine 140, the entity identification engine 150, the voice engine 160, and the conversation engine 170 is provided herein (e.g., with respect to FIGS. 2, 3, and 4).

Referring now to FIG. 2, an example process flow 200 for utilizing various components from the example environment of FIG. 1 is depicted. For the sake of example, assume that the automated assistant 115 receives an indication to initiate an automated telephone call 201. In some implementations, the automated assistant 115 can receive the indication to initiate the automated telephone call 201 based on user input that is received from a user of the client device 110. The user input can be, for example, spoken input directed to the automated assistant 115 and captured in audio data generated via microphone(s) of the client device 110, typed and/or touch input directed to the automated assistant 115 and captured in typed and/or touch data generated via a display or other input device of the client device 110, and/or other inputs (e.g., gesture inputs, etc.). In these implementations, the task identification engine 140 can process the user input (or a sequence of user inputs) to identify a task 202 to be performed during the automated telephone call (and optionally using data stored in the tasks database 140A). Further, the entity identification engine 150 can process the user input (or the sequence of user inputs) to identify an entity 203 to engage with during the automated telephone call (and optionally using data stored in the entities database 150A). For example, if the user input is “call Example Retailer and reserve Hot Christmas Toy for me”, then the task 202 to be performed can be “initiate an automated telephone call”, “conduct the automated telephone call”, and “reserve Hot Christmas Toy [for user]”, and the entity 203 can be a brick and mortar location of “Example Retailer” that is most geographically proximate to the user, that is typically visited by the user, etc. In these implementations, the automated assistant 115 that initiates the automated telephone call can be implemented locally at the client device 110 (e.g., via the automated telephone call system client 113) or remotely from the client device (e.g., via the automated telephone call system 120).

In additional or alternative implementations, the automated assistant 115 can receive the indication to initiate the automated telephone call 201 based on other signals that are in addition to user input that is received from a user of the client device 110. The other signals can include, for example, detecting a spike in query activity across a population of client devices in a certain geographical area. In these implementations, the task identification engine 140 can process the query activity to identify a task 202 to be performed during the automated telephone call. Further, the entity identification engine 150 can process the query activity and the particular geographic area to identify an entity 203 to engage with during the automated telephone call. For example, if a plurality of users submit a threshold quantity of queries for “availability of Hot Christmas Toy at Example Retailer”, and the plurality of users are located within a threshold distance of one another, the threshold quantity of the queries can be considered a spike in query activity. Accordingly, the task 202 to be performed can be “initiate an automated telephone call”, “conduct the automated telephone call”, and “inquire about availability of Hot Christmas Toy”, and the entity 203 can be one or more brick and mortar locations of “Example Retailer” that are also located within the particular geographic area. In these implementations, the automated assistant 115 that initiates the automated telephone call can be implemented remotely from the client device (e.g., via the automated telephone call system 120).

Subsequent to identifying the task 202 and/or the entity 203, the automated assistant 115 can cause the voice selection engine 161 to select an initial voice 204 to be utilized in generating one or more corresponding instances of synthesized speech to be rendered during the automated telephone call with the entity 203. In selecting the initial voice to be utilized by the automated assistant 115 and during the automated telephone call with the entity 203, the voice selection engine 161 can consider various criteria, such as a type of the entity 203, a particular location associated with the entity 203, whether a phone number associated with the entity 203 is a landline or non-landline, and/or other criteria. Continuing with the above examples, assume that the entity 203 that is identified is located in the Southeastern United States. In this example, the initial voice 204 can reflect that of a person from the Southeastern United States. In contrast, assume that the entity 203 that is identified is located in the Midwestern United States. In this example, the initial voice 204 can reflect that of a person from the Midwestern United States. As another example, assume that the type of the entity 203 that is identified is an Italian restaurant in the United States. In this example, the initial voice 204 can reflect that of a person from the United States with an Italian accent. In contrast, assume that the type of the entity 203 that is identified is a New York pizzeria in the United States. In this example, the initial voice 204 can reflect that of a person from New York.

In some implementations, the various voices described herein can be associated with different sets of prosodic properties (e.g., stored in the prosodic properties database 130B) that influence, for example, intonation, tone, stress, rhythm, and/or other properties of speech and how the speech is perceived. Accordingly, in these implementations, the different voices described herein can stored in association with respective sets of prosodic properties that are utilized by a TTS model (e.g., described above with respect to the TTS engine 134) in generating the one or more corresponding instances of synthesized speech to be rendered during the automated telephone call with the entity 203. In additional or alternative implementations, the various voices described herein can be associated with different TTS models (e.g., stored in the ML models database 130A). Accordingly, in these implementations, the different voices described herein can stored in association with respective TTS models (e.g., described above with respect to the TTS engine 134) in generating the one or more corresponding instances of synthesized speech to be rendered during the automated telephone call with the entity 203.

Subsequent to selecting the initial voice 204, the automated assistant 115 can initiate the automated telephone call with the entity 203. For example, the automated assistant 115 can obtain a telephone number associated with the entity 203 and utilize the telephone number in placing the automated telephone call. However, despite selecting the initial voice 204 for utilization during the automated telephone call, the automated assistant 115 can continuously monitor for one or more signals to determine whether to modify the initial voice 204 that was selected as indicated by 205. For example, the automated assistant 115 can cause the voice modification engine 162 to analyze content of a conversation 206 that is obtained by the conversation engine 170. The conversation 206 can include audio data capturing an interaction between the automated assistant 115 and a representative of the entity 203, a transcript of the interaction between the automated assistant 115 and a representative of the entity 203, and/or other content of the conversation 206. The representative of the entity 203 can be, for example, a human representative, a voice bot, an interactive voice response (IVR) system, etc.

In analyzing the content of the conversation 206, the voice modification engine 162 can dynamically adapt the initial voice 204 utilized in generating the one or more corresponding instances of synthesized speech to an alternative voice 207 that is predicted to maximize success of the automated assistant 115 performing the task 202 during the automated telephone call. For example, the voice modification engine 162 can process audio data that captures the conversation 206 (e.g., spoken inputs of the representative associated with the entity 203 and/or spoken inputs of the automated assistant 115) using various ML models (e.g., stored in the ML models database 130A) to determine whether to dynamically adapt the initial voice 204 to the alternative voice 207. For instance, the voice modification engine 162 can adapt the initial voice 204 (e.g., initially selected based on one or more criteria as described above with respect to the voice selection engine 161) to the alternative voice 207 (e.g., in an attempt to match a representative voice of the representative associated with the entity 203). Accordingly, in processing the audio data that captures the conversation 206, the voice modification engine 162 can employ a language identification ML model that is trained to predict a language being spoken by the representative associated with the entity 203 (e.g., English, Italian, Spanish, etc.), an accent identification voice classification ML model that is trained to predict an accent in the language being spoken by the representative associated with the entity 203 (e.g., a Southeastern United States accent in the English language, a Midwestern United States accent in the English language, etc.), a prosodic properties ML model that is trained to predict prosodic properties of speech of the representative associated with the entity 203, and/or other ML models. As a result, not only can the voice modification engine 162 determine a language being spoken by the representative associated with the entity 203, but also an accent of the language being spoken by the representative associated with the entity 203 and a cadence of the speech being spoken by the representative associated with the entity 203, and can cause the automated assistant 115 to reflect the language, accent, and cadence by switching to the alternative voice 207 (assuming that the initial voice 204 does not already reflect this).

Although the above example is described with respect to dynamically adapting the initial voice 204 to the alternative voice 207, it should be understood that is for the sake of example and is not meant to be limiting. For example, it should be understood that, throughout the conversation 206, the automated assistant 115 can switch back and forth between a plurality of different voices. However, in various implementations, the automated assistant 115 may only do so at certain points in the conversation 206. For instance, the automated assistant 115, may only change voices when the conversation 206 transitions from one representative associated with the entity 203 (e.g., an IVR system associated with the entity 203 or a human representative associated with the entity 203) to another representative associated with the entity (e.g., a human representative associated with the entity 203 or another human representative associated with the entity 203). Also, for example, while the automated assistant 115 is engaged in the conversation 206 associated with a given representative associated with the entity 203, the automated assistant 115 may only modify prosodic properties that are utilized in generating the one or more corresponding instances of synthesized speech to match the cadence of speech of the representative associated with the entity 203 to obviate mitigate and/or eliminate instances of confusion for the representative associated with the entity 203.

Notably, and in conducting the conversation 206 with the representative associated with the entity 203, the automated assistant 115 may include one or more unique personal identifiers (e.g., a name, an email address, a physical address, a username, a password, a name of an entity, a domain name, etc.). Accordingly, the automated assistant 115 can cause the unique personal identifier engine 163 to obtain textual content 208 that includes at least the one or more unique personal identifiers to be rendered as part of the conversation 206. Further, and in conducting the conversation 206 with the representative associated with the entity 203, the automated assistant 115 may inject one or more pauses into the one or more corresponding instances of synthesized speech. Accordingly, the automated assistant 115 can cause the pause engine 164 to determine where in the one or more corresponding instances of synthesized speech that one or more pauses 209 should be included and/or a duration of the one or more pauses 209. These implementations are described in more detail herein (e.g., with respect to FIGS. 4, 6A, 6B, 6C, and 6D).

Accordingly, the automated assistant 115 can utilize the voice (e.g., the initial voice 204, the alternative voice 207, or other voices) in generating synthesized speech 210 via the TTS engine 134, where the synthesized speech 210 captures textual content 208 (optionally including the one or more unique personal identifiers and optionally including the one or more pauses). In these and other manners described herein, the automated assistant 115 can perform the task 202 during the automated telephone call with the entity 203.

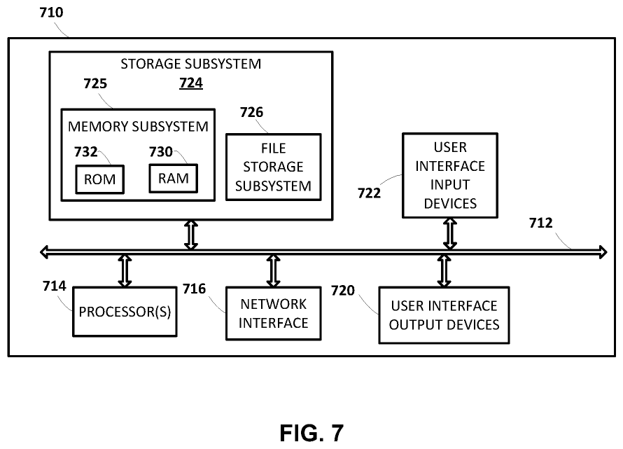

Turning now to FIG. 3, a flowchart illustrating an example method 300 of switching voices utilized by an automated assistant during an automated telephone call is depicted. For convenience, the operations of the method 300 are described with reference to a system that performs the operations. This system of the method 300 includes at least one processor, memory, and/or other component(s) of computing device(s) (e.g., client device 110 of FIG. 1, automated telephone call system 120 of FIG. 1, computing device 710 of FIG. 7, and/or other computing devices). Moreover, while operations of the method 300 are shown in a particular order, this is not meant to be limiting. One or more operations may be reordered, omitted, and/or added.

At block 352, the system identifies an entity for an automated assistant to engage with during an automated telephone call. For example, the system can cause the entity identification engine 150 to identify the entity for the automated assistant to engage with during the automated telephone call (e.g., as described with respect to the entity identification engine 150 in the process flow 200 of FIG. 2).

At block 354, the system selects an initial voice to be utilized by the automated assistant and during the automated telephone call. For example, the system can cause the voice selection engine 161 to select the initial voice to be utilized by the automated assistant and during the automated telephone call (e.g., as described with respect to the voice selection engine 161 in the process flow 200 of FIG. 2).

At block 356, the system initiates the automated telephone call. For example, the system can obtain a telephone number associated with the entity and cause the automated assistant to utilize the telephone number associated with the entity to initiate the automated telephone call.

At block 358, the system determines whether to select an alternative voice to be utilized, and in lieu of the initial voice, by the automated assistant and during the automated telephone call with the entity. For example, the system can cause the voice modification engine 162 to determine whether to select the alternative voice to be utilized, and in lieu of the initial voice, by the automated assistant and during the automated telephone call with the entity (e.g., as described with respect to the voice modification engine 162 in the process flow 200 of FIG. 2). In some implementations, the system can cause the voice modification engine 162 to determine whether to select the alternative voice before any synthesized speech is rendered during the automated telephone call (e.g., in response to analyzing audio data that captures a greeting of a representative associated with the entity). In additional or alternative implementations, the system can cause the voice modification engine 162 to determine whether to select the alternative voice subsequent to synthesized speech being rendered using the initial voice and during the automated telephone call (e.g., in response to analyzing audio data that captures a greeting of a representative associated with the entity). In various implementations, the operations of block 358 may be limited to certain points of the automated telephone call. For instance, the operations of block 358 may only be performed in response to receiving a first instance of audio data from a representative associated with the entity (e.g., a human representative associated with the entity, an IVR system associated with the entity, a voice bot associated with the entity, etc.), in response to the automated assistant being transferred from a first representative associated with the entity to a second representative associated with the entity, and so on.

If, at an iteration of block 358, the system determines not to select an alternative voice to be utilized, and in lieu of the initial voice, by the automated assistant and during the automated telephone call with the entity, then the system continues the automated telephone call using the initial voice. In continuing the automated telephone call using the initial voice, the system can generate one or more corresponding instances of synthesized speech audio data and in furtherance of performing a task and using the initial voice (e.g., a TTS model associated with the initial voice and/or prosodic properties associated with the initial voice as described with respect to the process flow 200 of FIG. 2). In some implementations, the task can be any task explicitly specified by a user for whom the automated assistant is conducting the automated telephone call, such as a restaurant reservation task, an appointment scheduling task, and/or any other task that can be specified by the user. In additional or alternative implementations, the task can be any task inferred based on query activity of a population of users for whom the automated assistant is conducting the automated telephone call, such as an inventory inquiry task and/or any other task that can be inferred across the population of users and based on their query activity. Notably, these tasks are often associated with parameters, and the one or more corresponding instances of synthesized speech audio data may include slot values for the parameters associated with these tasks (e.g., unique personal identifiers and/or other slot values) as described herein (e.g., with respect to FIGS. 5A-5B and 6A-6D). Also notably, in various implementations, the system can continue monitoring, throughout a remainder of the automated telephone call, for whether to select an alternative voice to be utilized, and in lieu of the initial voice, by the automated assistant and during the automated telephone call with the entity.

If, at an iteration of block 358, the system determines to select an alternative voice to be utilized, and in lieu of the initial voice, by the automated assistant and during the automated telephone call with the entity, then the system proceeds to block 360. At block 360, the system selects the alternative voice to be utilized, and in lieu of the initial voice, by the automated assistant and during the automated telephone call with the entity. The system can select the alternative voice (e.g., a TTS model associated with the alternative voice and/or prosodic properties associated with the alternative voice as described with respect to the process flow 200 of FIG. 2) in an attempt to increase a likelihood of the of the task being performed during the automated telephone call in a successful manner and as efficiently as possible, thereby concluding a human-to-machine interaction in a more quick and efficient manner.

At block 362, the system causes the automated assistant to utilize the alternative voice in continuing the automated telephone call with the entity. In continuing the automated telephone call using the alternative voice, the system can generate one or more of the corresponding instances of synthesized speech audio data and in furtherance of performing the task and using the alternative voice (e.g., the TTS model associated with the alternative voice and/or the prosodic properties associated with the alternative voice).

At block 364, the system determines a result of the automated telephone call with the entity. The system can determine the result of the automated telephone call based on one or more corresponding instances of audio data that are received from a representative associated with the entity. The result of the automated telephone call can be, for example, an indication of whether the task was successfully performed, details associated with performance of the task, and/or any other result of the automated telephone call. It should be noted that the result of the automated telephone call may vary depending on the task being performed during the automated telephone call.

At block 366, the system determines whether the automated telephone call was initiated based on user input. For example, in some implementations, the automated telephone call may be initiated based on user input (e.g., typed user input, touch user input, spoken user input, etc.). In these implementations, the user input (or a sequence of user inputs) may identify the entity to be engaged with during the automated telephone call, a task to be performed during the automated telephone call, slot value(s) for parameter(s) associated with the task to be performed during the automated telephone call, and/or other information related to performance of the automated telephone call by the automated assistant. As another example, in other implementations, the automated telephone call may be initiated based on analyzing query activity of a population of users in a certain geographical region. In these implementations, the query activity may be utilized to infer the entity to be engaged with during the automated telephone call, a task to be performed during the automated telephone call, slot value(s) for parameter(s) associated with the task to be performed during the automated telephone call, and/or other information related to performance of the automated telephone call by the automated assistant. Notably, the operations of block 366 may be performed prior to the entity being identified at the operations of block 352.

If, at an iteration of block 366, the system determines that the automated telephone call was initiated based on user input, then the system proceeds to block 368. At block 368, the system generates, based on the result, a notification. At block 370, the system causes the notification to be provided for presentation to a user that provided the user input. Accordingly, in implementations where the automated telephone call was initiated based on the user input, a user that provided the user input to initiate the automated telephone call can be alerted to the result of the automated telephone call (e.g., a result of performance of the task during the automated telephone call). Notably, the notification can be visually rendered via a display of a client device of the user and/or audibly rendered via speaker(s) of the client device of the user. The system returns to block 352 to perform an additional iteration of the method 300. However, it should be noted that multiple iterations of the method 300 (e.g., with multiple instances of the entity and/or multiple instances of an entity of the same type) can be performed in a parallel manner and/or a serial manner.

If, at an iteration of block 366, the system determines that the automated telephone call was not initiated based on user input, then the system proceeds to block 372. At block 372, the system updates, based on the result, one or more databases (e.g., database(s) 195 of FIG. 1). For example, the system can update one or more databases utilized by a web browser software application, a maps software application, or the like to ensure that the result of the automated telephone call can influence search results or the like in real-time or near real-time. The system returns to block 352 to perform an additional iteration of the method 300. Again, it should be noted that multiple iterations of the method 300 (e.g., with multiple instances of the entity and/or multiple instances of an entity of the same type) can be performed in a parallel manner and/or a serial manner.

Although the method 300 of FIG. 3 is not described with respect to dynamically adapting how unique personal identifiers or other textual content is rendered during the automated telephone call (e.g., as described with respect to FIGS. 2 and 4), it should be understood that is for the sake of example and is not meant to be limiting. Rather, it should be understood that the method 300 of FIG. 3 is described herein to illustrate some techniques contemplated herein.

Turning now to FIG. 4, a flowchart illustrating an example method 400 of dynamically adapting how unique personal identifiers are rendered during an automated telephone call is depicted. For convenience, the operations of the method 400 are described with reference to a system that performs the operations. This system of the method 400 includes at least one processor, memory, and/or other component(s) of computing device(s) (e.g., client device 110 of FIG. 1, automated telephone call system 120 of FIG. 1, computing device 710 of FIG. 7, and/or other computing devices). Moreover, while operations of the method 400 are shown in a particular order, this is not meant to be limiting. One or more operations may be reordered, omitted, and/or added.

At block 452, the system identifies an entity for an automated assistant to engage with during an automated telephone call. For example, the system can cause the entity identification engine 150 to identify the entity for the automated assistant to engage with during the automated telephone call (e.g., as described with respect to the entity identification engine 150 in the process flow 200 of FIG. 2).

At block 454, the system initiates the automated telephone call. For example, the system can obtain a telephone number associated with the entity and cause the automated assistant to utilize the telephone number associated with the entity to initiate the automated telephone call.

At block 456, the system identifies textual content to be provided for presentation to a representative associated with the entity, the textual content including at least a unique personal identifier. The textual content can be, for example, a slot value for a parameter that is associated with a task to be performed during the automated telephone call (e.g., as described with respect to FIGS. 5A-5B and 6A-6D). However, it should be understood that the textual content can include additional information that is in addition to the unique personal identifier. Further, it should be understood that the unique personal identifier that is included in the textual content may be based on a task being performed by the automated assistant during the automated telephone call and/or based on information requested from a representative associated with the entity during the automated telephone call.

At block 458, the system determines whether to generate synthesized speech that includes the unique personal identifier on a character-by-character basis and optionally with one or more pauses. In some implementations, the system can determine whether to generate the synthesized speech that includes the unique personal identifier on the character-by-character basis based on, for example, a frequency of the unique personal identifier, a length of the unique personal identifier, a complexity of the unique personal identifier, and/or other criteria.

For example, the system can cause the unique personal identifier engine 163 to interact with the unique personal identifiers database 163A to determine whether the frequency of the unique personal identifier satisfies a frequency threshold. In this example, the system can determine to generate the synthesized speech audio data that includes the unique personal identifier on the character-by-character basis in response to determining that the frequency of the unique personal identifier fails to satisfy the frequency threshold. In contrast, the system can determine to generate the synthesized speech audio data that includes the unique personal identifier on the non-character-by-character basis in response to determining that the frequency of the unique personal identifier satisfies the frequency threshold. Put another way, if the unique personal identifier is frequent in a lexicon of users (e.g., as indicted by data stored in the unique personal identifiers database 163A), then the system may determine to generate the synthesized speech audio data that includes the unique personal identifier on the non-character-by-character basis, but if the unique personal identifier is not frequent in a lexicon of users, then the system may determine to generate the synthesized speech audio data that includes the unique personal identifier on the character-by-character basis.

As another example, the system can cause the unique personal identifier engine 163 to determine whether the length of the unique personal identifier satisfies a length threshold. In this example, the system can determine to generate the synthesized speech audio data that includes the unique personal identifier on the character-by-character basis in response to determining that the length of the unique personal identifier satisfies the length threshold. In contrast, the system can determine to generate the synthesized speech audio data that includes the unique personal identifier on the non-character-by-character basis in response to determining that the length of the unique personal identifier fails to satisfy the length threshold. Put another way, if the unique personal identifier does not include characters beyond the threshold length, then the system may determine to generate the synthesized speech audio data that includes the unique personal identifier on the non-character-by-character basis, but if the unique personal identifier does include characters beyond the threshold length, then the system may determine to generate the synthesized speech audio data that includes the unique personal identifier on the character-by-character basis.

As yet another example, the system can cause the unique personal identifier engine 163 to determine whether the complexity of the unique personal identifier satisfies a complexity threshold. In this example, the system can determine to generate the synthesized speech audio data that includes the unique personal identifier on the character-by-character basis in response to determining that the complexity of the unique personal identifier satisfies the complexity threshold. In contrast, the system can determine to generate the synthesized speech audio data that includes the unique personal identifier on the non-character-by-character basis in response to determining that the complexity of the unique personal identifier fails to satisfy the complexity threshold. Put another way, if a combination of letters and/or numbers of the unique personal is relatively simple, then the system may determine to generate the synthesized speech audio data that includes the unique personal identifier on the non-character-by-character basis (e.g., “john25” can be rendered as “john” followed by “twenty-five”), but if a combination of letters and/or numbers of the unique personal is relatively complex, then the system may determine to generate the synthesized speech audio data that includes the unique personal identifier on the character-by-character basis (e.g., “j20h5n” can be rendered as “j”, “2”, “o”, “h”, “5”, “n”).

In some implementations, the system can determine whether to generate the synthesized speech that includes the unique personal identifier on the character-by-character basis based on, for example, a type of the representative of the entity with which the automated assistant is interacting with during the automated telephone call. For example, if the representative associated with the entity is a human representative, then the system may be more likely to render the unique personal identifier on the character-by-character basis. However, if the representative associated with the entity is an IVR system or voice bot representative, then the system may be more likely to render the unique personal identifier on the non-character-by-character basis (e.g., since the IVR system and/or the voice bot representative are likely to employ ASR model(s) to interpret any synthesized speech rendered by the automated assistant during the automated telephone call).

Although the above examples are described with respect to particular criteria being utilized in isolation, it should be understood that is for the sake of example and is not meant to be limiting. For instance, it should be understood that any combination of the above criteria may be utilized and that the examples are provided to illustrate techniques contemplated herein.

Further, in various implementations, the system can determine whether to generate the synthesized speech that injects the one or more pauses based on the same or similar criteria, but by leveraging the pause engine 164. For example, the system can cause the pause engine 164 to consider the frequency of the unique personal identifier, the length of the unique personal identifier, the complexity of the unique personal identifier, and/or other criteria in determining whether to inject the one or more pauses into the synthesized speech that includes the unique personal identifier. In these examples, the frequency of the unique personal identifier failing to satisfy the frequency threshold may result in the one or more pauses being injected into the synthesized speech, the length of the unique personal identifier satisfying the length threshold may result in the one or more pauses being injected into the synthesized speech, and the complexity of the unique personal identifier satisfying the complexity threshold may result in the one or more pauses being injected into the synthesized speech. Also, for example, the system can cause the pause engine 164 to consider the type of representative associated with the entity that the automated assistant is interacting with in determining whether to inject the one or more pauses into the synthesized speech that includes the unique personal identifier. In these examples, the automated assistant interacting with the human representative may result in the one or more pauses being injected into the synthesized speech (e.g., since the human is likely to record and/or otherwise act upon the unique personal identifier). Accordingly, it should be understood that not only can these particular criteria influence whether the unique personal identifier is rendered on the character-by-character basis, but can also influence whether the one or more pauses are injected into the synthesized speech and where the one or more pauses are injected into the synthesized speech.

If, at an iteration of block 462, the system determines to generate synthesized speech that includes the unique personal identifier on a character-by-character basis, then the system proceeds to block 460. At block 460, the system processes, using a text-to-speech (TTS) model, the textual content to generate the synthesized speech that includes the unique personal identifier on the character-by-character basis and optionally with the one or more pauses. The system then proceeds to block 464. The operations of block 464 are described in more detail below.

If, at an iteration of block 462, the system determines to generate synthesized speech that includes the unique personal identifier on a non-character-by-character basis, then the system proceeds to block 462. At block 462, the system processes, using a text-to-speech (TTS) model, the textual content to generate the synthesized speech that includes the unique personal identifier on the non-character-by-character basis and optionally with the one or more pauses. The system then proceeds to block 464.

At block 464, the system causes the synthesized speech to be audibly rendered for presentation to the representative associated with the entity. For example, the system can cause the synthesized speech to be audibly rendered via speaker(s) associated with a client device of the representative associated with the entity over one or more networks (e.g., PSTN, VoIP, etc.). The system returns to block 456 and continues with the method 400. However, it should be noted that multiple iterations of the method 400 can be performed in a parallel manner and/or a serial manner for different unique personal identifiers that are to be rendered during the automated telephone call.

Although the method 400 of FIG. 4 is not described with respect to selecting an initial voice and dynamically switching to an alternative voice utilized by an automated assistant during the automated telephone call (e.g., as described with respect to FIGS. 2 and 3), it should be understood that is for the sake of example and is not meant to be limiting. Rather, it should be understood that the method 400 of FIG. 4 is described herein to illustrate some techniques contemplated herein.

Turning now to FIGS. 5A and 5B, various non-limiting examples of switching voices utilized by an automated assistant during an automated telephone call are depicted. FIGS. 5A and 5B each depict a client device 110 (e.g., an instance of the client device 110 from FIG. 1) having a display 180. One or more aspects of an automated assistant associated with the client device 110 (e.g., an instance of the automated assistant 115 from FIG. 1) may be implemented locally on the client device 110 and/or on other client device(s) that are in network communication with the client device 110 in a distributed manner (e.g., via network(s) 199 of FIG. 1). For the sake of simplicity, operations of FIGS. 5A and 5B are described herein as being performed by the automated assistant 115. Although the client device 110 of FIGS. 5A and 5B is depicted as a mobile phone, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, and/or any other client device capable of making telephonic calls.

The display 180 of the client device 110 in FIGS. 5A and 5B further includes a textual input interface element 184 that the user may select to generate user input via a keyboard (virtual or real) or other touch and/or typed input, and a spoken input interface element 185 that the user may select to generate user input via microphone(s) of the client device 110. In some implementations, the user may generate user input via the microphone(s) without selection of the spoken input interface element 185. For example, active monitoring for audible user input via the microphone(s) may occur to obviate the need for the user to select the spoken input interface element 185. In some of those and/or in other implementations, the spoken input interface element 185 may be omitted. Moreover, in some implementations, the textual input interface element 184 may additionally and/or alternatively be omitted (e.g., the user may only provide audible user input). The display 180 of the client device 110 in FIGS. 5A and 5B also includes system interface elements 181, 182, 183 that may be interacted with by the user to cause the client device 110 to perform one or more actions.

Referring specifically to FIG. 5A, for the sake of example assume that a user of the client device 110 directs user input of “Call Example Italian Restaurant to see if they have gabagool and make me a reservation for tonight at 8:00 PM for two people if they do”. In this example, the task to be performed can be considered: (1) call “Example Italian Restaurant”; (2) inquire about availability of the gabagool at “Example Italian Restaurant”; and (3) make reservation for tonight at 8:00 PM for two people if “Example Italian Restaurant” has the gabagool. Accordingly, the automated assistant can identify the entity as indicated by 552A1 (e.g., “Example Italian Restaurant”) and based on the user input. Further assume that the user lives in the Southeastern US. Accordingly, the automated assistant can initially select a Southeastern US voice as indicated by 552A2 anticipating that an employee of “Example Italian Restaurant” will have a Southeastern US accent and/or vocabulary. Moreover, the automated assistant can initiate the automated telephone call with “Example Italian Restaurant” as indicated by 552A3 to perform the task.

Further assume that “Example Italian Restaurant” has a voice bot that utilizes an Italian US voice as indicated by 554A1 and the voice bot plays a greeting 554A2 of “Ciao, thank you for calling Example Italian Restaurant, please tell me how I can be of assistance today.” Accordingly, and in response to analyzing the greeting 554A2, the automated assistant can determine that the voice bot associated with “Example Italian Restaurant” utilizes an Italian US voice. In this example, and prior to causing any synthesized speech to be rendered, the automated assistant can determine to switch to an Italian US voice as indicated by 556A1 and then cause synthesized speech 556A2 of “Ahh Ciao, I was wondering if you all have the gabagool?”. Further assume that the voice bot plays a response 558A1 of “We are Example Italian Restaurant, of course we have the gabagool”. Accordingly, and in response to analyzing the response 558A1, the automated assistant can then cause synthesized speech 562A1 of “In that case, please transfer me to the hostess to make a reservation.”

Notably, in this example, the automated assistant can select the initial voice (e.g., the Southeastern US voice as indicated by 552A2) which it anticipates will result in the task being performed in a quick and efficient manner, such as the Southeastern US voice based on the user and “Example Italian Restaurant” being located in the Southeastern US. However, upon the automated telephone call being initiated, the automated assistant can dynamically adapt to the alternative voice (e.g., the Italian US voice as indicated by 556A1) after hearing the greeting 554A2 provided by the voice bot associated with “Example Italian Restaurant”.

Referring specifically to FIG. 5B, and continuing with the example from FIG. 5A, further assume that the voice bot associated with “Example Italian Restaurant” transfers the call to a human hostess associated with “Example Italian Restaurant”. Further assume that the human hostess has a Southeastern US voice as indicated by 562A1 and provides an additional greeting 562A2 of “Hey there, thanks for calling Example Italian Restaurant, what day and time would you like to make the reservation?” Accordingly, and in response to analyzing the additional greeting 562A2, the automated assistant can determine that the human hostess associated with “Example Italian Restaurant” utilizes a Southeastern US voice. In this example, and even though synthesized speech has already been rendered as part of the automated telephone call (e.g., the synthesized speech 556A2 and 560A1 from FIG. 5A), the automated assistant can determine to switch back to the Southeastern US voice as indicated by 564A1 and then cause synthesized speech 564A2 of “Hello, do you have any availability for tonight at 8:00 PM for two people? The name for the reservation is Todd” (e.g., where the user's surname is “Todd”). Further assume that the human hostess provides an additional response 568A1 of “We certainly do, see you tonight!” to indicate that the reservation was successfully made on behalf of the user.

Notably, in this example, the automated assistant can switch back from the alternative voice (e.g., the Italian US voice as indicated by 556A1) which it anticipates will result in the task being performed in a quick and efficient manner, such as the Italian US voice based on analyzing the greeting 554A2. However, upon the automated telephone call being transferred to the human hostess, the automated assistant can dynamically adapt back to the initial voice (e.g., the Southeastern US voice as indicated by 564A1) after hearing the additional greeting 562A2 provided by the human hostess associated with “Example Italian Restaurant”.

Although the example of FIGS. 5A and 5B is described with respect to selecting the initial voice, switching to the alternative voice, and then switching back to the initial voice throughout a duration of the automated telephone call, it should be understood that is for the sake of example and is not meant to be limiting. Rather, it should be understood that the example of FIGS. 5A and 5B is provided to illustrate various techniques contemplated herein (e.g., as described with respect to FIGS. 2 and 3). Further, although the example of FIGS. 5A and 5B is described with respect to different accents and/or vocabs corresponding to the different voices based on geographical regions, nationalities, etc., it should be understood that is for the sake of example and is not meant to be limiting. Rather, it should be understood that the alternative voice can have the same accent and/or vocab as the initial voice, but different prosodic properties may be utilized to change the rhythm, tempo, etc. of the synthesized speech to speed up, slow down, alter emphasis, etc. of the synthesized speech. Moreover, although the example of FIGS. 5A and 5B is not described with respect to determining how to render unique personal identifiers (e.g., the user's surname of “Todd”), it should be understood that is for the sake of example and is not meant to be limiting.

Turning now to FIGS. 6A, 6B, 6C, and 6D, various non-limiting examples of dynamically adapting how unique personal identifiers are rendered during an automated telephone call are depicted. FIGS. 6A, 6B, 6C, and 6D each depict a client device 110 (e.g., an instance of the client device 110 from FIG. 1) having a display 180. One or more aspects of an automated assistant associated with the client device 110 (e.g., an instance of the automated assistant 115 from FIG. 1) may be implemented locally on the client device 110 and/or on other client device(s) that are in network communication with the client device 110 in a distributed manner (e.g., via network(s) 199 of FIG. 1). For the sake of simplicity, operations of FIGS. 6A, 6B, 6C, and 6D are described herein as being performed by the automated assistant 115. Although the client device 110 of FIGS. 6A, 6B, 6C, and 6D is depicted as a mobile phone, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, and/or any other client device capable of making telephonic calls.

The display 180 of the client device 110 in FIGS. 6A, 6B, 6C, and 6D further includes a textual input interface element 184 that the user may select to generate user input via a keyboard (virtual or real) or other touch and/or typed input, and a spoken input interface element 185 that the user may select to generate user input via microphone(s) of the client device 110. In some implementations, the user may generate user input via the microphone(s) without selection of the spoken input interface element 185. For example, active monitoring for audible user input via the microphone(s) may occur to obviate the need for the user to select the spoken input interface element 185. In some of those and/or in other implementations, the spoken input interface element 185 may be omitted. Moreover, in some implementations, the textual input interface element 184 may additionally and/or alternatively be omitted (e.g., the user may only provide audible user input). The display 180 of the client device 110 in FIGS. 6A, 6B, 6C, and 6D also includes system interface elements 181, 182, 183 that may be interacted with by the user to cause the client device 110 to perform one or more actions.

Referring specifically to FIG. 6A, for the sake of example assume that a user of the client device 110 directs user input of “Call Example Italian Restaurant and make me a reservation for tonight at 8:00 PM for two people”. In this example, the task to be performed can be considered: (1) call “Example Italian Restaurant”; and (2) make reservation for tonight at 8:00 PM for two people. Accordingly, the automated assistant can identify the entity as indicated by 652A1 (e.g., “Example Italian Restaurant”) and based on the user input. Moreover, the automated assistant can initiate the automated telephone call with “Example Italian Restaurant” as indicated by 652A2 to perform the task.

Further assume that “Example Italian Restaurant” has a human hostess that answers the automated telephone call and provides a greeting 654A1 of “Ciao, thank you for calling Example Italian Restaurant, please tell me how I can be of assistance today.” Accordingly, and in response to analyzing the greeting 654A1, the automated assistant can determine that the human hostess is, in fact, a human. Nonetheless, further assume that the automated assistant causes synthesized speech 656A1 of “Hello, I would like to make a reservation for tonight at 8:00 PM for two people, do you have any availability? The name for the reservation is Todd” (e.g., where the user's surname is “Todd”). Further assume that the human hostess provides a response 658A1 of “Your reservation is set, see you tonight!” to indicate that the reservation was successfully made on behalf of the user.

Notably, in the example of FIG. 6A, the user's surname of “Todd” can be considered a unique personal identifier for the user of the client device 110. However, the unique personal identifier in the synthesized speech 656A1 is generated on a non-character-by-character basis and does not include any pauses. In this example, the automated assistant can determine to generate the synthesized speech 656A1 on the non-character-by-character basis based on, for example, the name “Todd” being a relatively frequent or common name in a lexicon of users in the US, the name “Todd” being of a relatively short length, the name “Todd” being relatively uncomplex, and/or based on other criteria (e.g., as described with respect to FIG. 4). Accordingly, the synthesized speech 656A1 can be rendered on the non-character-by-character basis and without any pauses to conclude the interaction in a more quick and efficient manner.

In contrast, and referring specifically to FIG. 6B, assume that the user's surname is “Carlsen” instead of “Todd”. In this example, and in generating synthesized speech 656B1, the automated assistant may determine to generate the synthesized speech 656B1 on a character-by-character basis. In this example, the automated assistant can determine to generate the synthesized speech 656B1 on the character-by-character basis based on, for example, the name “Carlsen” being a relatively infrequent or uncommon name in a lexicon of users in the US (e.g., compared to users in, for example, Scandinavian countries), the name “Carlsen” being of a relatively longer length, the name “Carlsen” being complex (e.g., whether “Carlsen” ends with “-sen” or “-son”), and/or based on other criteria (e.g., as described with respect to FIG. 4). Accordingly, the synthesized speech 656B1 can be rendered on the character-by-character basis and with pauses to conclude the interaction in a more quick and efficient manner by mitigating and/or eliminating instances in which the automated assistant may be asked to repeat the unique personal identifier and/or a character of the unique personal identifier.

Additionally, or alternatively, and referring specifically to FIG. 6C, again assume that the user's surname is “Carlsen” instead of “Todd”. In this example, and in generating synthesized speech 656C1, the automated assistant may determine not only to generate the synthesized speech 656C1 on a character-by-character basis, but also to inject one or more pauses into the synthesized speech 656C1. In this example, the automated assistant can determine to generate the synthesized speech 656B1 on the character-by-character basis based on, for example, the name “Carlsen” being a relatively infrequent or uncommon name in a lexicon of users in the US (e.g., compared to users in, for example, Scandinavian countries), the name “Carlsen” being of a relatively longer length, the name “Carlsen” being complex (e.g., whether “Carlsen” ends with “-sen” or “-son”), and/or based on other criteria (e.g., as described with respect to FIG. 4). Further, the automated assistant can determine to generate the synthesized speech 656C1 with the one or more pauses based on, for example, the name “Carlsen” being a relatively infrequent or uncommon name in a lexicon of users in the US (e.g., compared to users in, for example, Scandinavian countries), the name “Carlsen” being of a relatively longer length, the name “Carlsen” being complex (e.g., whether “Carlsen” ends with “-sen” or “-son”), and/or based on other criteria (e.g., as described with respect to FIG. 4). However, it should be noted that the automated assistant may determine to generate synthesized speech including the unique personal identifier of “Carlsen” without on a non-character-by-character basis and without injecting any pauses in certain scenarios. Accordingly, the synthesized speech 656C1 can be rendered on the character-by-character basis and with pauses to conclude the interaction in a more quick and efficient manner by mitigating and/or eliminating instances in which the automated assistant may be asked to repeat the unique personal identifier and/or a character of the unique personal identifier.

For example, and referring specifically to FIG. 6D, again assume that the user's surname is “Carlsen” instead of “Todd”. However, rather than the human hostess associated with “Example Italian Restaurant” answering the automated telephone call, assume that a voice bot associated with “Example Italian Restaurant” answers the automated telephone call. In this example, further assume the voice bot provides a greeting 654D1 of “Ciao, thank you for calling Example Italian Restaurant, please tell me how I can be of assistance today.” Accordingly, and in response to analyzing the greeting 654D1, the automated assistant can determine that the voice bot is, in fact, not a human. Nonetheless, further assume that the automated assistant causes synthesized speech 656D1 of “Hello, I would like to make a reservation for tonight at 8:00 PM for two people, do you have any availability? The name for the reservation is Carlsen”. Further assume that the voice bot provides a response 658D1 of “Your reservation is set, see you tonight!” to indicate that the reservation was successfully made on behalf of the user.

Notably, in the example of FIG. 6D, the unique personal identifier in the synthesized speech 656D1 is generated on a non-character-by-character basis and does not include any pauses. In this example, the automated assistant can determine to generate the synthesized speech 656D1 on the non-character-by-character basis based on, for example, the representative associated with the entity being voice bot that utilizes ASR model(s) in processing the synthesized speech 656D1, such that the ASR model(s) are likely to correctly interpret the unique personal identifier and that the pauses are more likely to cause confusion that make it easier for the voice bot to interpret the unique personal identifier. Accordingly, the synthesized speech 656D1 can be rendered on the non-character-by-character basis and without any pauses to conclude the interaction in a more quick and efficient manner.

Although FIGS. 6A-6D are described with respect to certain examples, it should be understood that those examples are described herein to illustrate various techniques contemplated herein and are not meant to be limiting. Rather, it should be understood that the techniques described herein can be adapted to different tasks that the user requests the automated assistant to perform, based on audio data that captures inputs of a representative associated with an entity, and so on.

Turning now to FIG. 7, a block diagram of an example computing device 710 that may optionally be utilized to perform one or more aspects of techniques described herein. In some implementations, one or more of a client device, remote system component(s), and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touchscreen incorporated into the display (e.g., a touch sensitive display), audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods disclosed herein, as well as to implement various components depicted in FIGS. 1 and 2.

These software modules are generally executed by processor 714 alone or in combination with other processors. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem 712 may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes identifying an entity for an automated assistant to engage with during an automated telephone call; selecting an initial voice to be utilized by the automated assistant and during the automated telephone call with the entity, the initial voice to be utilized by the automated assistant in generating one or more corresponding instances of synthesized speech to be rendered during the automated telephone call with the entity; initiating the automated telephone call with the entity; and during the automated telephone call with the entity: determining whether to select an alternative voice to be utilized, and in lieu of the initial voice, by the automated assistant and during the automated telephone call with the entity; and in response to determining to select the alternative voice to be utilized by the automated assistant and during the automated telephone call with the entity: selecting the alternative voice to be utilized by the automated assistant and during the automated telephone call with the entity, the alternative voice to be utilized by the automated assistant in generating the one or more corresponding instances of synthesized speech to be rendered during the automated telephone call with the entity; and causing the automated assistant to utilize the alternative voice in continuing with the automated telephone call.

These and other implementations of technology disclosed herein can optionally include one or more of the following features.

In some implementations, the initial voice may be associated with a first set of prosodic properties, the alternative voice may be associated with a second set of prosodic properties, and the second set of prosodic properties may differ from the first set of prosodic properties.

In some versions of those implementations, the method may further include, when the initial voice is being utilized by the automated assistant and during the automated telephone call with the entity: processing, using a text-to-speech (TTS) model, textual content to be provided for presentation to a representative associated with the entity and the first set of prosodic properties to generate one or more of the corresponding instances of synthesized speech audio data. The method may further include, when the alternative voice is being utilized by the automated assistant and during the automated telephone call with the entity: processing, using the TTS model, the textual content to be provided for presentation to the representative associated with the entity and the second set of prosodic properties to generate one or more of the corresponding instances of synthesized speech audio data.

In some implementations, the initial voice may be associated with a first text-to-speech (TTS) model, the alternative voice may be associated with a second TTS model, wherein the second TTS model may differ from the first TTS model.

In some versions of those implementations, the method may further include, when the initial voice is being utilized by the automated assistant and during the automated telephone call with the entity: processing, using the first TTS model, textual content to be provided for presentation to a representative associated with the entity to generate one or more of the corresponding instances of synthesized speech audio data. The method may further include, when the alternative voice is being utilized by the automated assistant and during the automated telephone call with the entity: processing, using the second TTS model, the textual content to be provided for presentation to the representative associated with the entity to generate one or more of the corresponding instances of synthesized speech audio data.

In some implementations, selecting the initial voice to be utilized by the automated assistant and during the automated telephone call with the entity may be based on one or more of: a type of the entity, a particular location associated with the entity, or whether a phone number associated with the entity is a landline or non-landline.

In some implementations, determining whether to select the alternative voice to be utilized, and in lieu of the initial voice, by the automated assistant and during the automated telephone call with the entity may be based on analyzing content received upon initiating the automated telephone call with the entity.

In some versions of those implementations, the content received upon initiating the automated telephone call with the entity may include audio data from a representative that is associated with the entity or an interactive voice response (IVR) system that is associated with the entity.

In additional or alternative versions of those implementations, determining whether to select the alternative voice to be utilized, and in lieu of the initial voice, by the automated assistant and during the automated telephone call with the entity may be prior to any of the one or more corresponding instances of synthesized speech audio data being rendered.

In additional or alternative versions of those implementations, determining whether to select the alternative voice to be utilized, and in lieu of the initial voice, by the automated assistant and during the automated telephone call with the entity may be subsequent to one or more of the corresponding instances of synthesized speech audio data being rendered.

In some implementations, identifying the entity for the automated assistant to engage with during the automated telephone call may be based on user input that is received at a client device of a user, and the automated assistant may initiate and conduct the automated telephone call on behalf of the user.

In some versions of those implementations, the method may further include, subsequent to the automated assistant completing the automated telephone call: generating, based on a result of the automated telephone call, a notification; and causing the notification to be rendered for presentation to the user via the client device.

In some additional or alternative versions of those implementations, the automated assistant may be executed locally at the client device of the user.

In some additional or alternative versions of those implementations, the automated assistant may be executed remotely from the client device of the user.

In some implementations, identifying the entity for the automated assistant to engage with during the automated telephone call may be based on a spike in query activity across a population of client devices in a certain geographical area, and the automated assistant may initiate and conduct the automated telephone call on behalf of the population of client devices.

In some further versions of those implementations, the method may further include, subsequent to the automated assistant completing the automated telephone call: updating, based on a result of the automated telephone call, one or more databases.

In some even further versions of those implementations, the one or more databases may be associated with a web browser software application or a maps software application.

In additional or alternative further versions of those implementations, the automated assistant may be a cloud-based automated assistant.

In some implementations, the method may further include, in response to determining to not select the alternative voice to be utilized by the automated assistant and during the automated telephone call with the entity: causing the automated assistant to utilize the initial voice in continuing with the automated telephone call.

In some implementations, initiating the automated telephone call with the entity may include: obtaining a telephone number associated with the entity; and initiating, telephone number associated with the entity, the automated telephone call.

In some implementations, a method implemented by one or more processors is provided, and includes identifying an entity for an automated assistant to engage with during an automated telephone call; initiating the automated telephone call with the entity; and during the automated telephone call with the entity: identifying textual content to be provided for presentation to a representative associated with the entity, the textual content including a unique personal identifier; determining, based on the representative associated with the entity and/or based on the unique personal identifier, whether to generate synthesized speech audio data that includes the unique personal identifier on a character-by-character basis or the unique personal identifier on a non-character-by-character basis; and in response to determining to generate the synthesized speech audio data that includes the unique personal identifier on the character-by-character basis: processing, using a text-to-speech (TTS) model, the textual content to generate the synthesized speech audio data that includes the unique personal identifier on the character-by-character basis; and causing the synthesized speech audio data to be audibly rendered for presentation to the representative associated with the entity.

These and other implementations of technology disclosed herein can optionally include one or more of the following features.

In some implementations, determining whether to generate the synthesized speech audio data that includes the unique personal identifier on the character-by-character basis or the unique personal identifier on the non-character-by-character basis may be based on the representative associated with the entity.

In some versions of those implementations, determining to generate the synthesized speech audio data that includes the unique personal identifier on the character-by-character basis may be in response to determining that the representative associated with the entity is a human representative.

In additional or alternative versions of those implementations, determining to generate the synthesized speech audio data that includes the unique personal identifier on the non-character-by-character basis may be in response to determining that the representative associated with the entity is an automated assistant representative.

In some implementations, determining whether to generate the synthesized speech audio data that includes the unique personal identifier on the character-by-character basis or the unique personal identifier on the non-character-by-character basis may be based on the unique personal identifier, and determining whether to generate the synthesized speech audio data that includes the unique personal identifier on the character-by-character basis or the unique personal identifier on the non-character-by-character basis may be based on one or more of: a frequency of the unique personal identifier, a length of the unique personal identifier, or a complexity of the unique personal identifier.

In some versions of those implementations, determining to generate the synthesized speech audio data that includes the unique personal identifier on the character-by-character basis may be in response to determining that the frequency of the unique personal identifier fails to satisfy a frequency threshold.

In some further versions of those implementations, determining to generate the synthesized speech audio data that includes the unique personal identifier on the non-character-by-character basis may be in response to determining that the frequency of the unique personal identifier satisfies the frequency threshold.

In additional or alternative versions of those implementations, determining to generate the synthesized speech audio data that includes the unique personal identifier on the character-by-character basis may be in response to determining that the length of the unique personal identifier satisfies a length threshold.

In some further additional or alternative versions of those implementations, determining to generate the synthesized speech audio data that includes the unique personal identifier on the non-character-by-character basis may be in response to determining that the length of the unique personal identifier fails to satisfy the length threshold.

In additional or alternative versions of those implementations, determining to generate the synthesized speech audio data that includes the unique personal identifier on the character-by-character basis may be in response to determining that the complexity of the unique personal identifier satisfies a complexity threshold.

In some further additional or alternative versions of those implementations, determining to generate the synthesized speech audio data that includes the unique personal identifier on the non-character-by-character basis may be in response to determining that the complexity of the unique personal identifier fails to satisfy the complexity threshold.

In some implementations, determining whether to generate the synthesized speech audio data that includes the unique personal identifier on the character-by-character basis or the unique personal identifier on the non-character-by-character basis may be based on both the representative associated with the entity and the unique personal identifier.

In some implementations, the unique personal identifier may be one or more of: a name, an email address, a physical address, a username, a password, a name of an entity, or a domain name.

In some implementations, the method may further include, in response to determining to generate the synthesized speech audio data that includes the unique personal identifier on the non-character-by-character basis: processing, using a text-to-speech (TTS) model, the textual content to generate the synthesized speech audio data that includes the unique personal identifier on the non-character-by-character basis; and causing the synthesized speech audio data to be audibly rendered for presentation to the representative associated with the entity.

In some implementations, a method implemented by one or more processors is provided, and includes identifying an entity for an automated assistant to engage with during an automated telephone call; initiating the automated telephone call with the entity; and during the automated telephone call with the entity: identifying textual content to be provided for presentation to a representative associated with the entity, the textual content including a unique personal identifier; determining, based on the representative associated with the entity and/or based on the unique personal identifier, whether to inject one or more pauses into synthesized speech audio data that includes the unique personal identifier; and in response to determining to inject the one or more pauses into the synthesized speech audio data that includes the unique personal identifier: processing, using a text-to-speech (TTS) model, the textual content to generate the synthesized speech audio data that includes the unique personal identifier and the one or more pauses; and causing the synthesized speech audio data to be audibly rendered for presentation to the representative associated with the entity.

These and other implementations of technology disclosed herein can optionally include one or more of the following features.

In some implementations, determining whether to inject the one or more pauses into synthesized speech audio data that includes the unique personal identifier may be based on the representative associated with the entity.

In some versions of those implementations, determining to inject the one or more pauses into the synthesized speech audio data that includes the unique personal identifier may be in response to determining that the representative associated with the entity is a human representative.

In additional or alternative versions of those implementations, determining to not inject the one or more pauses into the synthesized speech audio data that includes the unique personal identifier may be in response to determining that the representative associated with the entity is an automated assistant representative.

In some implementations, determining whether to inject the one or more pauses into synthesized speech audio data that includes the unique personal identifier may be based on the unique personal identifier, and determining whether to inject the one or more pauses into synthesized speech audio data that includes the unique personal identifier may be based on one or more of: a frequency of the unique personal identifier, a length of the unique personal identifier, or a complexity of the unique personal identifier.

In some further versions of those implementations, determining to inject the one or more pauses into the synthesized speech audio data that includes the unique personal identifier may be in response to determining that the frequency of the unique personal identifier fails to satisfy a frequency threshold.

In some further versions of those implementations, determining to not inject the one or more pauses into the synthesized speech audio data that includes the unique personal identifier may be in response to determining that the frequency of the unique personal identifier satisfies the frequency threshold.

In additional or alternative versions of those implementations, determining to inject the one or more pauses into the synthesized speech audio data that includes the unique personal identifier may be in response to determining that the length of the unique personal identifier satisfies a length threshold.

In some further additional or alternative versions of those implementations, determining to not inject the one or more pauses into the synthesized speech audio data that includes the unique personal identifier may be in response to determining that the length of the unique personal identifier fails to satisfy the length threshold.

In additional or alternative versions of those implementations, determining to inject the one or more pauses into the synthesized speech audio data that includes the unique personal identifier may be in response to determining that the complexity of the unique personal identifier satisfies a complexity threshold.

In some further additional or alternative versions of those implementations, determining to not inject the one or more pauses into the synthesized speech audio data that includes the unique personal identifier may be in response to determining that the complexity of the unique personal identifier fails to satisfy the complexity threshold.

In some implementations, determining whether to inject the one or more pauses into synthesized speech audio data that includes the unique personal identifier may be based on the unique personal identifier is based on both the representative associated with the entity and the unique personal identifier.

In some implementations, the unique personal identifier may be one or more of: an email address, a physical address, a username, a password, a name of an entity, or a domain name.

In some implementations, the method may further include, in response to determining to not inject the one or more pauses into the synthesized speech audio data that includes the unique personal identifier: processing, using a text-to-speech (TTS) model, the textual content to generate the synthesized speech audio data that includes the unique personal identifier and without the one or more pauses; and causing the synthesized speech audio data to be audibly rendered for presentation to the representative associated with the entity.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
identifying an entity for an automated assistant to engage with during an automated telephone call;
selecting an initial voice to be utilized by the automated assistant and during the automated telephone call with the entity, the initial voice to be utilized by the automated assistant in generating one or more corresponding instances of synthesized speech to be rendered during the automated telephone call with the entity;
initiating the automated telephone call with the entity; and
during the automated telephone call with the entity:
determining whether to select an alternative voice to be utilized, and in lieu of the initial voice, by the automated assistant and during the automated telephone call with the entity; and
in response to determining to select the alternative voice to be utilized by the automated assistant and during the automated telephone call with the entity:
selecting the alternative voice to be utilized by the automated assistant and during the automated telephone call with the entity, the alternative voice to be utilized by the automated assistant in generating the one or more corresponding instances of synthesized speech to be rendered during the automated telephone call with the entity; and
causing the automated assistant to utilize the alternative voice in continuing with the automated telephone call.

2. The method of claim 1, wherein the initial voice is associated with a first set of prosodic properties, wherein the alternative voice is associated with a second set of prosodic properties, and wherein the second set of prosodic properties differs from the first set of prosodic properties.

3. The method of claim 2, further comprising:
when the initial voice is being utilized by the automated assistant and during the automated telephone call with the entity:
processing, using a text-to-speech (TTS) model, textual content to be provided for presentation to a representative associated with the entity and the first set of prosodic properties to generate one or more of the corresponding instances of synthesized speech audio data; and
when the alternative voice is being utilized by the automated assistant and during the automated telephone call with the entity:
processing, using the TTS model, the textual content to be provided for presentation to the representative associated with the entity and the second set of prosodic properties to generate one or more of the corresponding instances of synthesized speech audio data.

4. The method of claim 1, wherein the initial voice is associated with a first text-to-speech (TTS) model, wherein the alternative voice is associated with a second TTS model, and wherein the second TTS model differs from the first TTS model.

5. The method of claim 4, further comprising:
when the initial voice is being utilized by the automated assistant and during the automated telephone call with the entity:
processing, using the first TTS model, textual content to be provided for presentation to a representative associated with the entity to generate one or more of the corresponding instances of synthesized speech audio data; and
when the alternative voice is being utilized by the automated assistant and during the automated telephone call with the entity:
processing, using the second TTS model, the textual content to be provided for presentation to the representative associated with the entity to generate one or more of the corresponding instances of synthesized speech audio data.

6. The method of claim 1, wherein selecting the initial voice to be utilized by the automated assistant and during the automated telephone call with the entity is based on one or more of: a type of the entity, a particular location associated with the entity, or whether a phone number associated with the entity is a landline or non-landline.

7. The method of claim 1, wherein determining whether to select the alternative voice to be utilized, and in lieu of the initial voice, by the automated assistant and during the automated telephone call with the entity is based on analyzing content received upon initiating the automated telephone call with the entity.

8. The method of claim 7, wherein the content received upon initiating the automated telephone call with the entity comprises audio data from a representative that is associated with the entity or an interactive voice response (IVR) system that is associated with the entity.

9. The method of claim 7, wherein determining whether to select the alternative voice to be utilized, and in lieu of the initial voice, by the automated assistant and during the automated telephone call with the entity is prior to any of the one or more corresponding instances of synthesized speech audio data being rendered.

10. The method of claim 7, wherein determining whether to select the alternative voice to be utilized, and in lieu of the initial voice, by the automated assistant and during the automated telephone call with the entity is subsequent to one or more of the corresponding instances of synthesized speech audio data being rendered.

11. The method of claim 1, wherein identifying the entity for the automated assistant to engage with during the automated telephone call is based on user input that is received at a client device of a user, and wherein the automated assistant initiates and conducts the automated telephone call on behalf of the user.

12. The method of claim 11, further comprising:
subsequent to the automated assistant completing the automated telephone call:
generating, based on a result of the automated telephone call, a notification; and
causing the notification to be rendered for presentation to the user via the client device.

13. The method of claim 11, wherein the automated assistant is executed locally at the client device of the user.

14. The method of claim 11, wherein the automated assistant is executed remotely from the client device of the user.

15. The method of claim 1, wherein identifying the entity for the automated assistant to engage with during the automated telephone call is based on a spike in query activity across a population of client devices in a certain geographical area, and wherein the automated assistant initiates and conducts the automated telephone call on behalf of the population of client devices.

16. The method of claim 15, further comprising:
subsequent to the automated assistant completing the automated telephone call:
updating, based on a result of the automated telephone call, one or more databases.

17. The method of claim 16, wherein the one or more databases are associated with a web browser software application or a maps software application.

18. The method of claim 15, wherein the automated assistant is a cloud-based automated assistant.

19. A system comprising:
at least one processor; and
memory storing instructions that, when executed by the at least one processor, cause the at least one processor:
identify an entity for an automated assistant to engage with during an automated telephone call;
select an initial voice to be utilized by the automated assistant and during the automated telephone call with the entity, the initial voice to be utilized by the automated assistant in generating one or more corresponding instances of synthesized speech to be rendered during the automated telephone call with the entity;
initiate the automated telephone call with the entity; and
during the automated telephone call with the entity:
determine whether to select an alternative voice to be utilized, and in lieu of the initial voice, by the automated assistant and during the automated telephone call with the entity; and
in response to determining to select the alternative voice to be utilized by the automated assistant and during the automated telephone call with the entity:
select the alternative voice to be utilized by the automated assistant and during the automated telephone call with the entity, the alternative voice to be utilized by the automated assistant in generating the one or more corresponding instances of synthesized speech to be rendered during the automated telephone call with the entity; and
cause the automated assistant to utilize the alternative voice in continuing with the automated telephone call.

20. A non-transitory computer-readable storage medium storing instructions that, when executed by at least one processor, cause the at least one processor to be operable to:
identifying an entity for an automated assistant to engage with during an automated telephone call;
selecting an initial voice to be utilized by the automated assistant and during the automated telephone call with the entity, the initial voice to be utilized by the automated assistant in generating one or more corresponding instances of synthesized speech to be rendered during the automated telephone call with the entity;
initiating the automated telephone call with the entity; and
during the automated telephone call with the entity:
determining whether to select an alternative voice to be utilized, and in lieu of the initial voice, by the automated assistant and during the automated telephone call with the entity; and
in response to determining to select the alternative voice to be utilized by the automated assistant and during the automated telephone call with the entity:
selecting the alternative voice to be utilized by the automated assistant and during the automated telephone call with the entity, the alternative voice to be utilized by the automated assistant in generating the one or more corresponding instances of synthesized speech to be rendered during the automated telephone call with the entity; and
causing the automated assistant to utilize the alternative voice in continuing with the automated telephone call.
